(19) United States
(12) Patent Application Publication
(10) Pub. No.: US 2005/0240909 A1
(43) Pub. Date: Oct. 27, 2005

(54) System and method for compiling multi-media applications

(75) Inventor: John R. Tersigni, Bloomsbury, NJ (US)

Correspondence Address: ARENT FOX PLLC, 1050 CONNECTICUT AVENUE, N.W., SUITE 400, WASHINGTON, DC, 20036, US

(73) Assignee: Reckoningboard Communications, Inc.

(21) Appl. No.: 11/113,182

(22) Filed: Apr. 25, 2005

Related U.S. Application Data
(60) Provisional application No. 60/564,940, filed on Apr. 26, 2004.

(51) Int. Cl. G06F 9/45

(52) U.S. Cl. 717/140

(57) ABSTRACT

A method and system for displaying a multimedia portfolio. The method includes the steps of establishing a multimedia portfolio with an identifier; preparing a multimedia content associated with a predetermined topic; selecting a predetermined template for the display of the multimedia content; compiling the multimedia content based on the predetermined template; and displaying the multimedia portfolio. The system includes a processor; a user interface functioning via the processor; a repository accessible by the processor; and a receiving means for receiving data for the processor. The processor, based on the data received from the receiving means, establishes a multimedia portfolio with an identifier, prepares a multimedia content associated with a predetermined topic, and displays the multimedia portfolio.

### CROSS-REFERENCE TO RELATED APPLICATIONS

The present utility application claims priority and is related to U.S. provisional application Ser. No. 60/564,940, filed Apr. 26, 2004, the entirety of which is hereby incorporate by reference herein.

### BACKGROUND OF THE INVENTION

1 Field of the Invention

The present invention relates to the method of and system for publishing and displaying a multimedia portfolio having multimedia contents. In particular, the present invention provides a method and a system for assimilating, compiling, inserting, sharing or network enabling multimedia information, such as an individual user's biographical or other multimedia information.

2 Description of the Related Art

Each year, thousands of students go through the higher education application process by submitting college applications. These applications generally require students to manually compile and present their biographical history/information on hard copies, such as paper applications. The information included in these applications include high school transcripts, Scholastic Aptitude Test scores, American College Testing scores, other test scores, Grade Point Average academic projects, professional projects, professional experiences, accomplishments, work history, and the like. The traditional college application, in its paper form, typically does not provide the student with any creative expression to reveal and present more about the particular student.

Similarly, each year thousands of people seek new employment by submitting a paper resume to the potential employer. The applicant's paper resume also typically does not provide any creative expression to reveal and present more about the particular applicant.

Therefore, among other things, there is an urgent need to provide a user such as a student or an individual seeking employment, with the capability to assimilate, compile, insert multimedia biographical content, data and information, and to have the option to publish the multimedia contents on a network site (e.g., the World Wide Web, referred to interchangeably herein as “the Web”), or publish the multimedia contents on a host site.

### SUMMARY OF THE INVENTION

The present invention provides a method for displaying a multimedia portfolio. The method of the present invention allows a user to establish a multimedia portfolio and prepare multimedia content associated with a predetermined topic. In addition, the method of the present invention allows a user to select a predetermined template for the display of the multimedia content compile the multimedia content based on the predetermined template and display the multimedia portfolio.

In addition, the present invention provides a system for displaying a multimedia portfolio, via a processor, a user interface functioning via the processor, a repository accessible by the processor, and a receiving device for receiving data for the processor. The processor of the system, based on the data received from the receiving device, establishes a multimedia portfolio with an identifier, prepares a multimedia content associated with a predetermined topic, and displays the multimedia portfolio.

Furthermore, the present invention includes a computer-readable storage medium storing a computer-readable program for executing a method for displaying a multimedia portfolio. The method includes the steps of establishes a multimedia portfolio with an identifier; and prepares a multimedia content associated with a predetermined topic. In addition, the method of the present invention selects a predetermined template for the display of the multimedia content; compiles the multimedia content based on the predetermined template; and displays the multimedia portfolio.

### BRIEF DESCRIPTION OF THE DRAWINGS

The foregoing and other objects, features, and advantages of the invention will become more readily apparent upon reference to the following detailed description of a presently preferred embodiment, when taken in conjunction with the accompanying drawings in which:

FIGS. 1-5 show example graphical user interface (GUI) screens of an exemplary Portfolio Manager Module, in accordance with an embodiment of the present invention;

FIGS. 6-8 show example GUI screens of an exemplary Editor Module, in accordance with an embodiment of the present invention;

FIGS. 9A-9B illustrate example GUI screens of an exemplary Publisher Module, in accordance with an embodiment of the present invention;

FIGS. 10-19 illustrate example GUI screens of an exemplary Editor Module, in accordance with an embodiment of the present invention;

FIGS. 20-26 illustrate example GUI screens of an exemplary Template Module, in accordance with an embodiment of the present invention;

FIG. 27 shows an exemplary computer network system for use, in accordance with an embodiment of the present invention;

FIG. 28 illustrates an exemplary multimedia compiling and publishing system, for use in accordance with an embodiment of the present invention;

FIG. 29 shows an exemplary storage system for storing multimedia contents, for use in accordance with an embodiment of the present invention; and

FIGS. 30-33 illustrate a flow diagram of a method and system for assimilating, compiling, inserting and network enabling multimedia information, in accordance with an embodiment of the present invention.

### DETAILED DESCRIPTION OF THE INVENTION

The present invention may be implemented using hardware, software or a combination thereof and may be implemented in one or more computer systems or other processing systems. In particular, the preferred embodiment of the invention can operate on an individual's computing system such as a personal computer with supporting applications operating thereon, or the invention can operate on an individual's computing system together with one or more network servers connected to a communication network, such as the Internet, the World Wide Web, Local Area Network, Wide Area Network, wireless communication network, etc., and any combination thereof, with additional supporting applications operating on both the individual's personal computing system and the network server(s) to carry out the functionality described herein.

The preferred embodiment of the present invention provides a method and a system for assimilating, compiling, inserting and network enabling multimedia information, such as an individual user's biographical multimedia information or multimedia information for presentation purposes, interchangeably referred to herein as “Digitally₁₃U.” For example, one exemplary embodiment provides a user, such as a student or an individual seeking employment, with the capability to assimilate, compile, insert multimedia biographical content, data and information, and to provide the user with the option to publish the multimedia contents as a stand alone network site or on a host site.

In particular, embodiment can be utilized for applying to college, or for applying for a job. The invention is configured to provide employment acceptance reasoning features, and hiring-evaluation features. Also, it provides features that can emulate the thought process of a college admissions officer, other college decision-makers, coaches who view college application material, and graduate school admissions officers, as well as employers. Therefore, this embodiment of the present invention can benefit the college, graduate school, and employee applicant by enhancing the existing college and employment application process that is currently void of multimedia academic and work performance contents.

For example, Digitally₁₃ U improves the ability of college applicants, grad school applicants, and employment seekers to better communicate with decision makers in the absence of a face-to-face interview by allowing the user to produce personal video, radio-style reporting of subject matters, and sound enhanced photo-journalism style essays, together with high school transcript and other information, such as SAT scores, ACT scores, other test scores, GPA academic projects, professional projects, professional experiences, accomplishments, work history, and the like. The entire content inputted by the user can be presented in any combination of personal media events that becomes the user's multimedia broadcast “resume.” The invention also significantly improves the turnaround time in the creation of a multimedia network site, and improves performance of multimedia Web sites with the use of file reduction features.

The exemplary embodiment described above includes, among other features: 1) a portfolio manager that allows users to create different multimedia biographical thematic content for different digital portfolios; 2) a multimedia GUI editor that allows users to select and insert any combination of personal media events for network site creation and that also manipulates a database, such as an Extensible Markup Language database, via a schema to keep track of the user's progress; 3) a previewer that allows users to automatically select different network templates and themes and insert all personal media events into a final network site prior to launching; 4) an exporter that allows user to export the multimedia contents to the publisher; 5) a publisher that allows the user to automatically launch the multimedia Web site; 6) a calendar that serves as a reminder to the user as to when to add multimedia content during a calendar year; and 7) a virtual advisor/counselor that provides video captured assistance for the use of the entire product.

Through these features, this embodiment of Digitally_U allows a user to create a file or a portfolio that can include digital media contents, such as video, sound, pictures, images, or documents, to be viewed as a presentation or to be published, for example, on a Web site.

In one embodiment, Digitally_U provides four or more components that work together in creating and publishing the user's portfolio. The four components of this embodiment include the Portfolio Manager, the Editor, the Template Manager and the Publisher. Each of these components and their functionality are described in the sections below.

Portfolio Manager

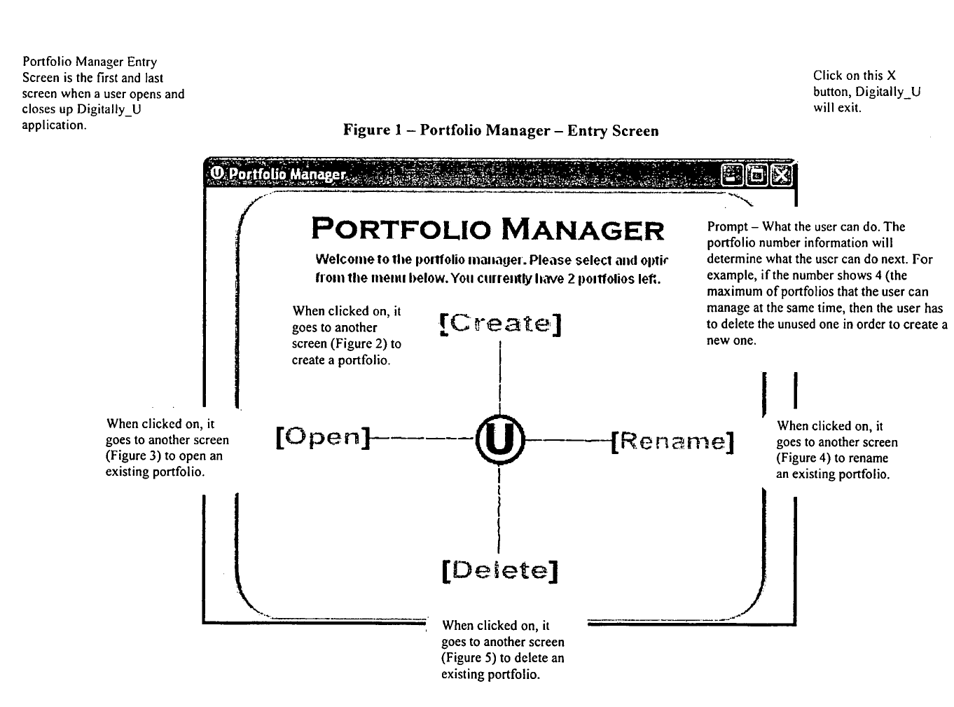

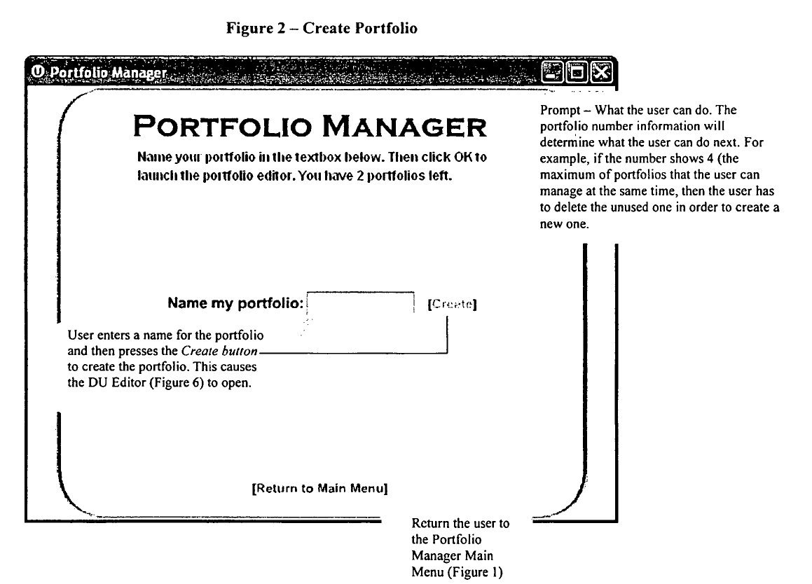

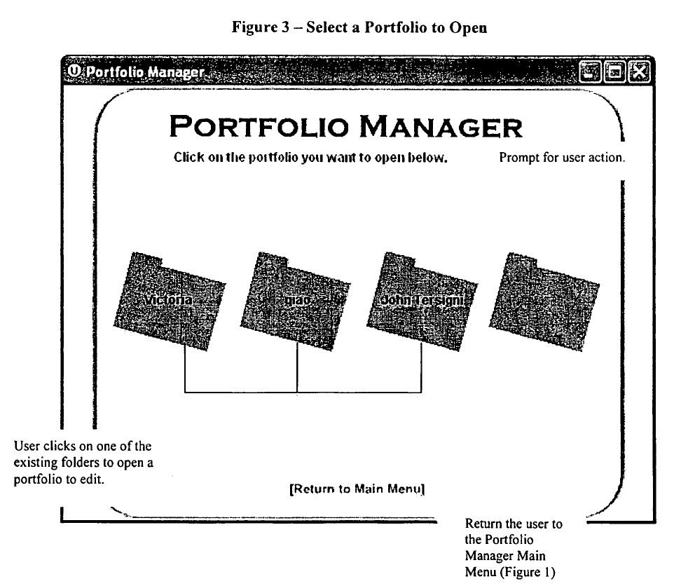

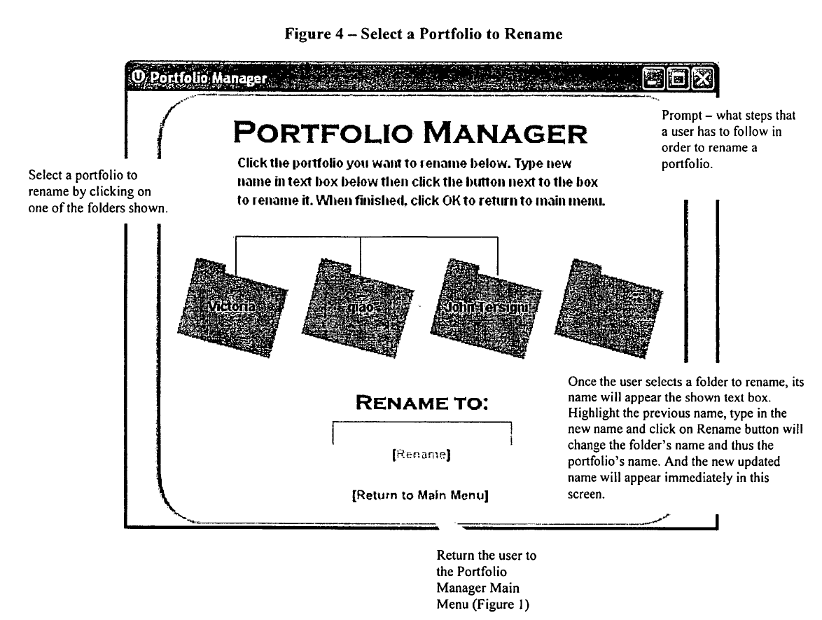

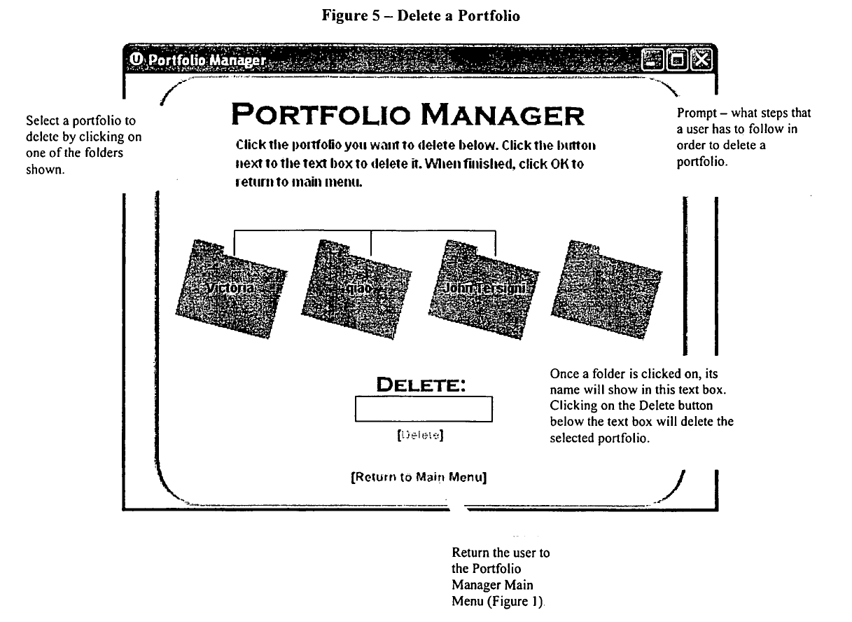

FIG. 1 provides an example of a “GUI” screen of the present embodiment. In particular, FIG. 1 illustrates a Portfolio Manager GUI screen that offers a user the capibility to create a new portfolio, to name or rename the portfolios, to open existing portfolios, and to delete portfolios. The Portfolio Manager also tracks how many portfolios a user has created. A predetermined number of portfolios can be active and open at a time.

In the exemplary embodiment, the Portfolio Manager's main menu is shown in FIG. 1 and is available to the user when the feature is accessed. The main menu has four options: [Create], [Open], [Rename] and [Delete]. The Portfolio Manager's main menu may be, for example, the first and last screen when a user accesses and exits the GUI of the embodiment. The main menu provides a “Prompt” to the user with helpful information or instructions. For example, the Prompt can indicate the number of unnamed portfolio(s) available. The main menu also provides the user with an option to exit the application. For example, FIG. 1 provides an “X” button on the upper right of the GUI screen, which will exit the user from the application selected.

Creating a Portfolio

When a user accesses the [Create] option by clicking on the word or by other accessing means, the present invention provides the user with another GUI screen, as shown in FIG. 2. In the example shown in FIG. 2, a user can enter a title identifying or naming the portfolio in the “Name my portfolio:” field, which accepts alpha-numeric characters and symbols. Each portfolio can have a unique name or identifier, for example,. If the user tries to create two portfolios with the same identifier, then the present invention will inform the user that the identifier entered is already in use. Once an identifier is entered, the user can access the [Create] button, which causes the present invention to provide the user with the Editor component, for example as shown in FIG. 6. For instance, clicking on the [Create] button will automatically launch the Editor module of the application and exit the Portfolio Manager so that a user can begin building a new portfolio.

Opening a Portfolio

FIG. 3 illustrates an exemplary GUI screen of the present invention that allows the user to open an existing portfolio. To open a portfolio, the user accesses the folder with the name of the portfolio the user wishes to open. For example, the user can access the desired folder by positioning a cursor on the portfolio and clicking on it. Clicking on a blank folder will not open anything. The blank folders, as shown if FIG. 3, can be used, for example, as indicators of the remaining portfolios available to the user out of a total predetermined maximum numbers.

Clicking on the [Open] button will close the Portfolio Manager and launch the Editor component of the present invention.

Renaming a Portfolio

FIG. 4 illustrates an exemplary GUI screen of the present invention that allows the user to rename an existing portfolio. To rename a portfolio, the user accesses the folder with the name of the portfolio the user wishes to rename. The name will then be displayed in the “Rename To:” field. For example, the user can access the desired folder by positing a cursor on the portfolio and clicking on it, whereby the name will appear in the field. Once the name of the portfolio appears, the user can replace the current name with the new name and click the [Rename] button. Subsequently, the new name will be displayed on the folder.

Once a user is finished renaming a portfolio, the user can access the [Return to Main Menu] option button to return to the Main Menu, as shown in FIG. 1. Returning to the Main Menu allows the user to select another option from the Main Menu, or exit the Portfolio Manager by accessing the Close button. In this exemplary embodiment, the Close option is the “X” button positioned on the top right corner of the GUI screen.

Deleting a Portfolio

FIG. 5 illustrates an exemplary GUI screen of the present invention that allows the user to delete an existing portfolio. To delete a portfolio, the user accesses the folder with the name of the portfolio the user wishes to delete. The name will then be displayed in the “Delete:” field. For example, the user can access the desired folder by positioning a cursor on the portfolio and clicking on it, whereby the name will appear in the field. Once the name of the portfolio appears, the user can choose to delete the portfolio and the entire content associated therewith by clicking the [Delete] button. Subsequently, the name of the deleted portfolio will no longer appear on any of the folders.

Once a user is finished deleting a portfolio, the user can access the [Return to Main Menu] option button to return to the Main Menu, as shown in FIG. 1. Returning to the Main Menu allows the user to select another option from the Main Menu, or to exit the Portfolio Manager by accessing the Close button. In this exemplary embodiment, the Close option is the “X” button positioned on the top right corner of the GUI screen.

Editor

FIG. 6 illustrates an example of a GUI screen of the Editor module of the present invention, which enables a user to compile multimedia information, contents and data by way of selecting the multimedia for the portfolio. The Editor is automatically launched when the user selects either the [Create] or [Open] options in the Portfolio Manager menu, for example.

In the present example, the Editor module provides a “topics” section bar that can categorize specific topics for the portfolio. The Editor shown in FIG. 6 offers six topic sections in a portfolio, but the present invention is not limited to six such topics. The six topic in this example are Quick Bio, About Me, Leadership, Activities and Experiences, In Addition and Contact Info. These topic section names reflect the types of information in which college admissions officers are typically interested. All topic sections allow a predetermined number of media events. However, the present invention can limit certain topic sections, such as Quick Bio and Contact Info which can only allow for the insertion of an image, as these sections are designed to link the information being presented to you in a quick and efficient manner.

As illustrated in FIG. 6, these topic sections are listed at the top of the screen. A user can access a topic section, for example, by positioning a cursor thereon and selecting. The particular topic section that is selected will appear in the brackets [ ]. The section currently chosen appears here as well. In this example, The Quick Bio and Contact Info sections enable the input only of image events, including five multimedia events per section, although the present invention is not limited to five events.

Furthermore, FIG. 6 illustrates an example of the default GUI screen that appears when the user selects to create a new portfolio or to open an existing portfolio. The sections featuring Quick Bio and Contact Info in share similar interfaces because these two sections allow users to add images and fill in text fields. For the remaining four sections in this example (About Me, Leadership, Activities and Experiences and In Addition), the user has more options as to how many multimedia events the user wants to include in each section and what types of multimedia events the user wishes to add. The Editor default page provides a title bar indicating the title of the portfolio the user is currently working on.

System Menu

The Editor module of the present example also includes a systems menu disposed in the upper right corner of the screen that includes the Calendar function, the Preview function, the Export function, the Publish function, the Save function, and the Help function. Although the present example as shown in FIG. 6 provides for six functions, the present invention is not limited to only to these six. When a systems menu function is selected, the present invention will execute the application related to that function.

For example, clicking on the “Calendar” button launches an interactive calendar that can remind the user of important dates, such as deadlines and tasks for filing a college application or preparing for college admissions. Similarly, clicking on the “Preview” button will launch the Template Manager, wherein the user can select a template for displaying or publishing the user's multimedia contents, and preview the completed template in Browser.

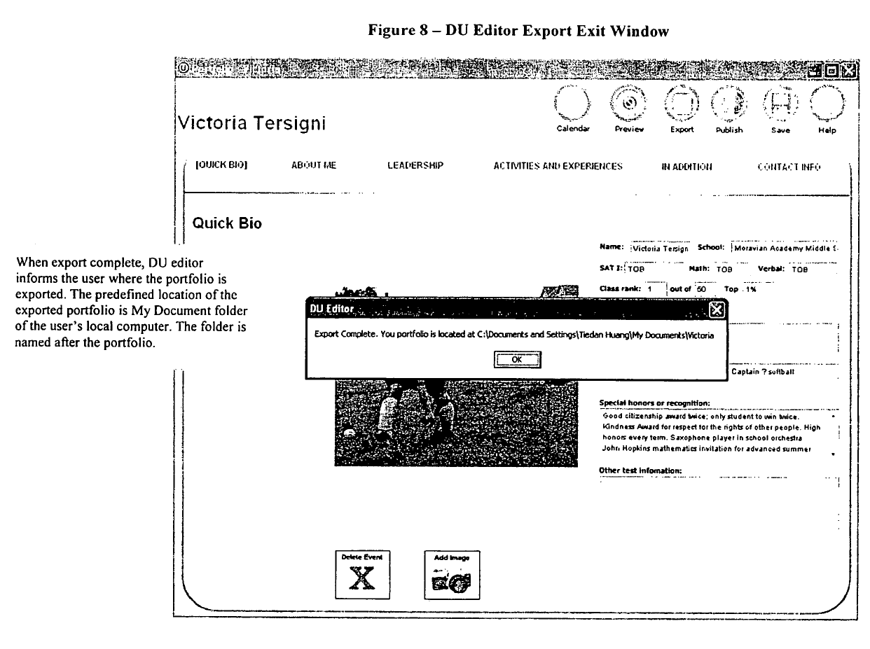

The “Export” function is able to collect all the resources that have been added to the portfolio and package them in a self-contained folder titled by the portfolio name, which is included, for example, under a folder. For instance, the folder can be the “My Documents” folder of the user's local computer. When exporting is complete, the preferred embodiment can alert the user where the exported portfolio is located, as shown in FIG. 8.

In one embodiment, the “Export” process is selected before publishing the portfolio on a network site. For example, when changes are made to the portfolio in the Editor module, the “Export” procedure should be selected and executed to update the portfolio with the new information. This is the process that creates the folder structure to be published, for example, to the Internet. This folder structure is created, for example, in the My Documents folder in a folder that has the same name given to the portfolio during the “create” process in the Portfolio Manager. The media contained in this folder is published to the Internet.

During the export process, the preferred embodiment can perform a resizing function on the images selected to make the file sizes smaller. This function does not change the original image file, but creates a copy of the image with a smaller file size, and places the copy into the portfolio folder structure.

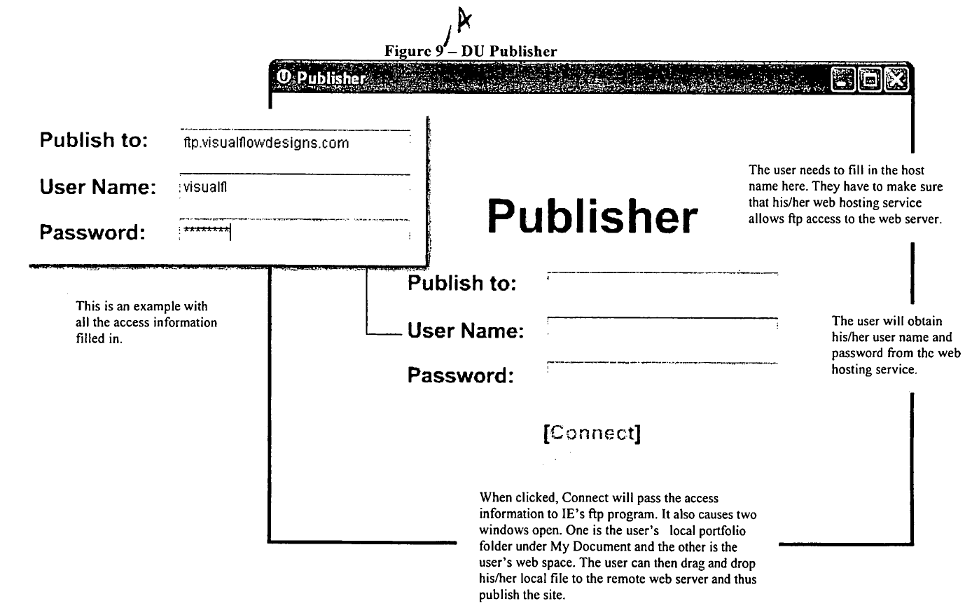

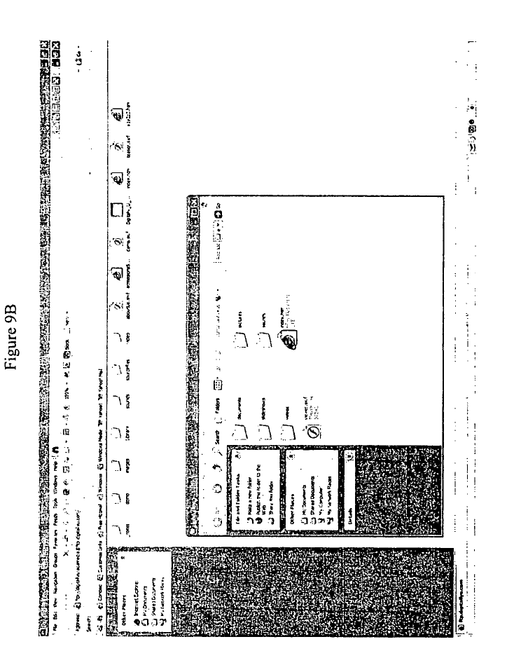

When the “Publish” feature is accessed, the present example causes the Publisher module, as shown in FIG. 9, to open. The Publisher can collect user login information and send it over to Internet Explorer's native File Transfer Program, which allows the user to upload the file to the desired Web server or other network locations.

For example, selecting the “Publish” function launches the internal publishing tool. This tool allows the user to enter the information, for example, provided by a web site hosting service, so that the contents of the exported folder structure can be placed on the site. The Export function is typically selected when changes are made to the portfolio, before the Publish function is selected.

The present invention also allows the use of an FTP program. If this option is selected, the folder to be published is located in another folder such as the My Documents folder. The folder will have the same name that the user gave the portfolio during the creation process. Export of any changes to the portfolio are typically made prior to publishing.

The “Save” feature is able to record paths of all the resources, such as multimedia data and files, and stores them in user data files, such as XML user data files. For instance, the “Save” feature enables the user to save any changes made to the portfolio, close and exit the application, and edit the portfolio at a later time. The system can be set to prompt the user to save any changes, such as every time the user closes the Editor program.

When selecting the “Help” feature, the present example launches an interactive Help Manual, which can give extensive directions and instructions on navigating through the system. Clicking the “X” button located on the upper right corner will return the user to the Portfolio Manager Main Screen.

The “Quick Bio” topic section offers the user tools to compile basic information about the user with an accompanying representative image. At the center of FIG. 6, the present example provides a media container, which can hold the inserted representative image. When a user selects the “Add Image” button, and selects a desired image, the image is imported and placed in the media container, to be part of the “Quick Bio” topic section. To the right of the media container, as shown in FIG. 6, text fields are provided for accepting the user's textual input, such as name, school, SAT scores, class rank, etc.

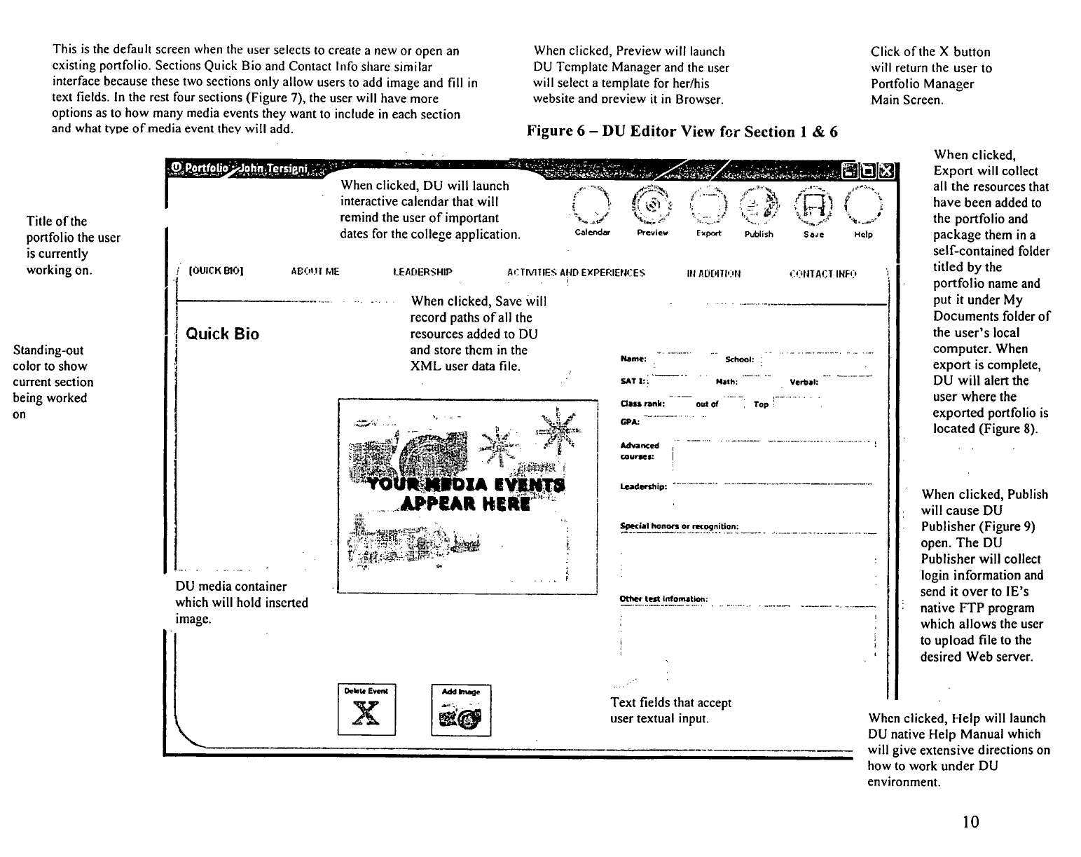

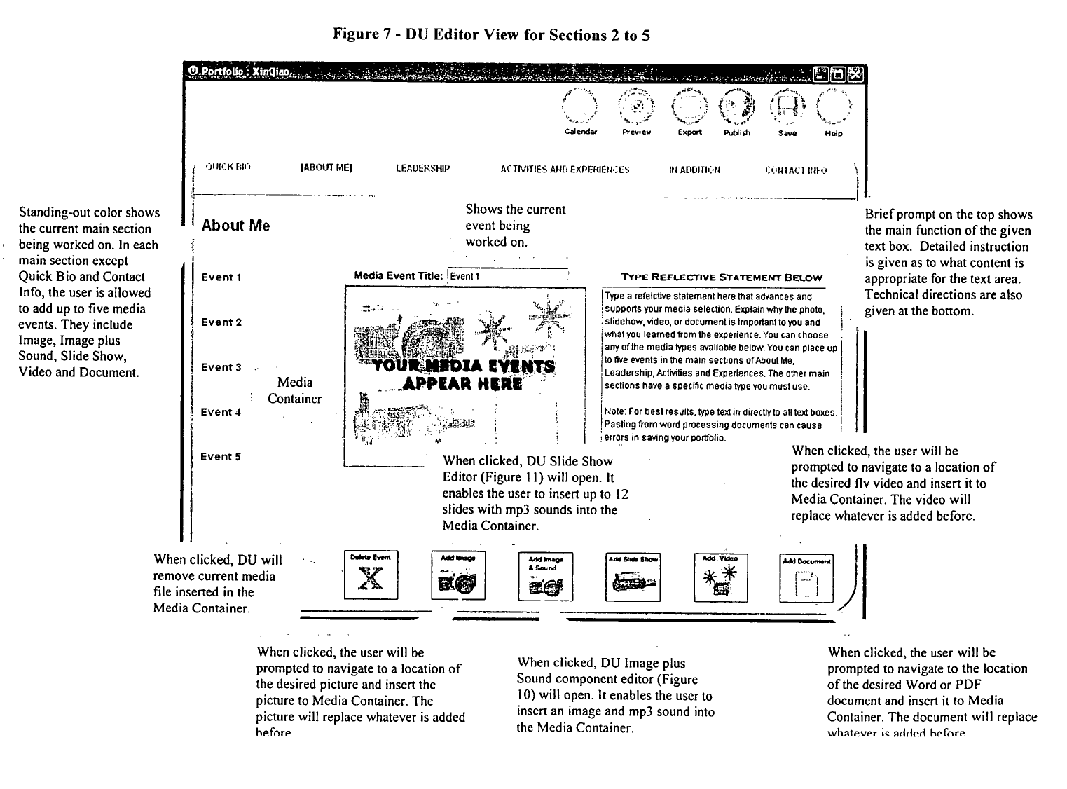

FIG. 7 shows an example of a GUI screen for the “About Me” topic section of the one embodiment of the present invention. The “About Me” topic section allows the user to compile a more expansive collection of information pertaining to the user.

For example, the “About Me” topic section of the GUI screen can contain an event listing portion, a media event title field, a media container box, a reflective statement entry box, and a media insertion/deletion bar, with options such as Delete Event, Add Image, Add Image & Sound, Add Slide Show, Add Video and Add Document.

The event listing portion of the screen provides the user with a view of a plurality of events under this topic section. In this example, a user is permitted to include and add up to five media events. Each event title is entered at the “Media Event Title:” character field. A user can navigate between events by selecting any one of the listed events by, for example, clicking on that event. Once the desired event is selected and the contents thereof are displayed, the “Media Event Title:” field shows the current event name.

For each media event inserted, the present invention, in this example, provides the user with a statement entry box for entering a brief text description of the media event inserted in the corresponding media container. The text can be typed directly into the statement text box. The statement, in this example, can be a complement to the media event chosen. For example, a user can explain and emphasize the importance of the photograph, slideshow, video or document inserted as the media event.

The media insertion/deletion bar, with options such as Delete Event, Add Image, Add Image & Sound, Add Slide Show, Add Video and Add Document, provider tools to control the insertion or deletion of the multimedia content. Selecting any one of the media insertion/deletion buttons executes the application related to the specific features of the tool. For example, positioning a cursor on the button and clicking on the type of media button will add that particular media into the media container. Some media types may require different procedural steps than others.

Once a particular type of media content is selected, the present example of the invention allows the user to either change the selection by reselecting that media type from the insertion bar, or change to another media type, at any time, by using one of the other buttons. It is not necessary to delete the first media event type to replace it with another media event type.

Delete Event

The Delete Event button is provided to remove a current media file that has been inserted in the media container. For example, if a user no longer wishes to have an event included as part of the overall portfolio, and does not wish to replace it with another event, then accessing the Delete Event button will remove the media event from the portfolio.

Add Image

The Add Image button allows the user to add a picture file to media event as part of the portfolio. When the Add Image button is selected, the user is prompted to navigate to a location where picture files are stored. For example, selecting the Add Image button can open a file selection window listing picture files in any format such as JPEG, TIF, EPS, or the like. The user navigates within the file selection window and selects the picture file/folder containing the desired picture to be added to the portfolio. Upon doing so, the selected image will appear in the Editor application module as part of the portfolio.

Add Image & Sound

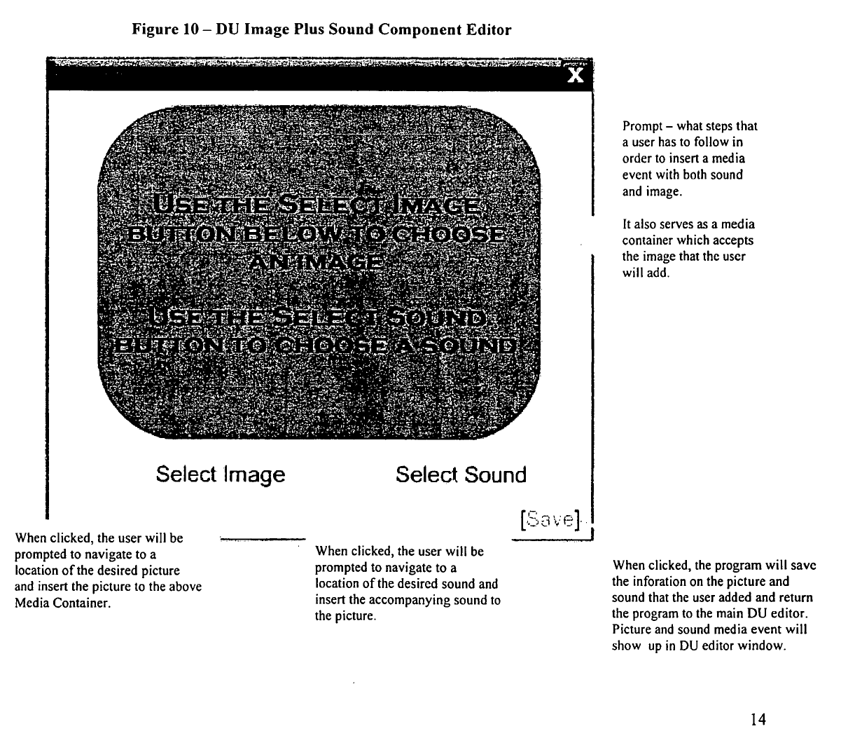

The Add Image & Sound button is provided to add a picture file, along with accompany sound, as part of the portfolio. When the Add Image & Sound button is selected, an Image and Sound selection tool of the Editor, as shown in FIG. 10, for example, is made available to the user. In particular, the Image and Sound tool enables the user to insert an image file along with a sound file into the media container. The image file can be in any format, such as JPEG, TIF, EPS, or the like; and the sound file can also be in any format, such as MP3.

In the present example, the Image and Sound selection tool, as shown in FIG. 10, provides instructions for the user to insert a media event containing both image and sound, and also provides an image selection, a sound selection and a save feature. The instructions for the user appear in a display box, for example. In addition, the display box can also serve as a media container that accepts the image to be added. When an image selection option is selected, such as selecting the “Select Image” button, the user is prompted to navigate to a location where picture files are stored, and inserts a desired picture to the media container. The procedure is similar to some extent to the procedure for adding an image, as disclosed above. When a sound selection option is selected, such as selecting the “Select Sound” button, the user is prompted to navigate to a location where sound files are stored. The user then selects the desired sound to accompany the selected imagem and inserts the selected sound.

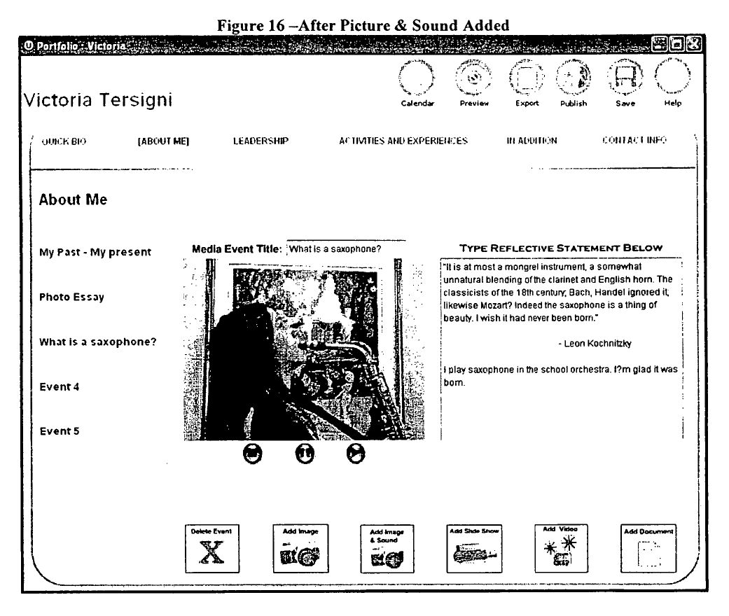

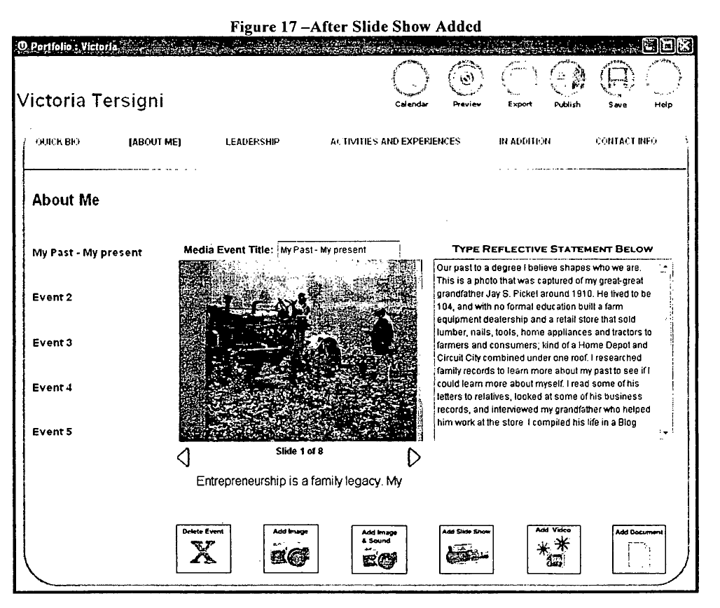

Once the selections are completed, accessing the save option will save both the image and the sound selections. For example, the present invention matches the selected image with the selected sound when the “Save” button is used, and both files are included as part of the portfolio. Selecting the save option also returns the application to the main Editor module, and the selected image and sound media event appear in the Editor window display. FIG. 16 shows an example of the present embodiment, in which where the selected image and selected sound have been saved and displayed in the Editor window.

The Editor window also enables the playback of the selected sound. For example, the user can listen to the selected sound accompanying the selected image by selecting a “play” feature within the Editor window. As FIG. 16 illustrates, the Editor window provides a stop button 160, a pause button 161, and a play sound button 162. Selecting the play sound button 162 commences the playing of the sound selected.

Add Slide Show

Another tool of the media insertion/deletion bar shown in FIG. 7 is the “Add Slide Show” selection button. When selected, the Editor module enables the insertion of a predetermined amount of image files, which are presented together as a slide show, along with sound files, into the media container.

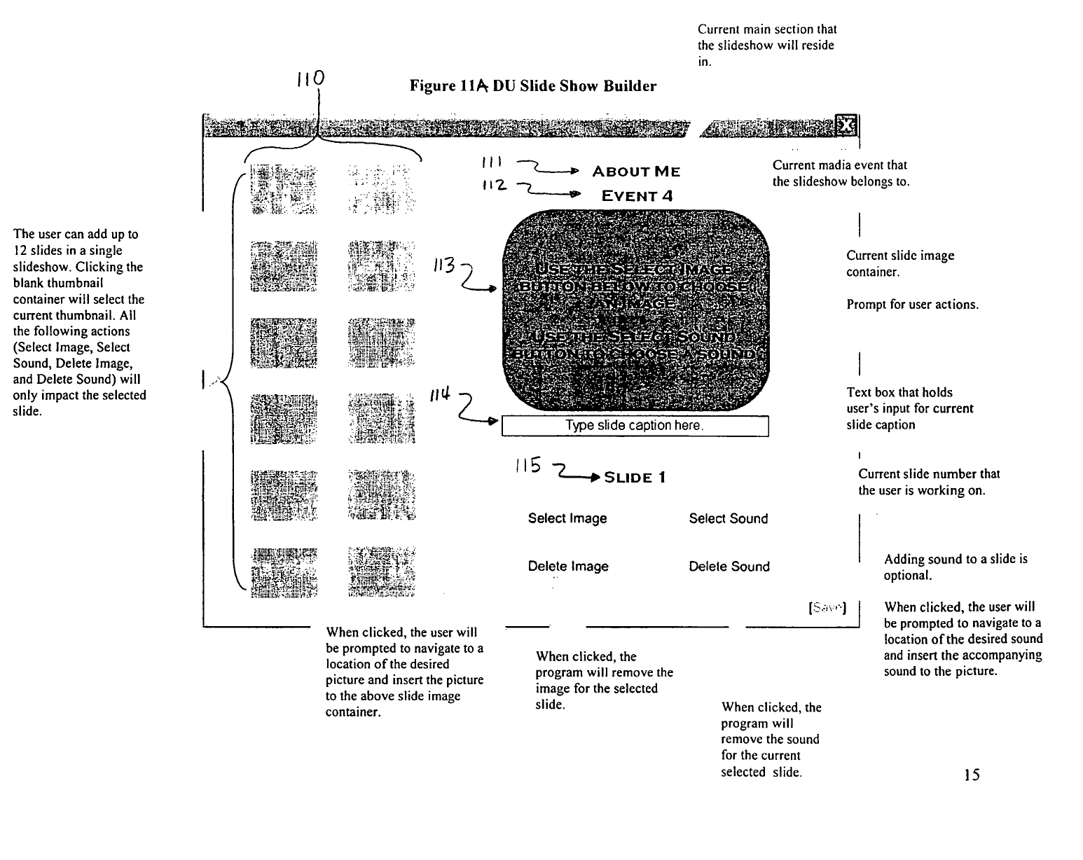

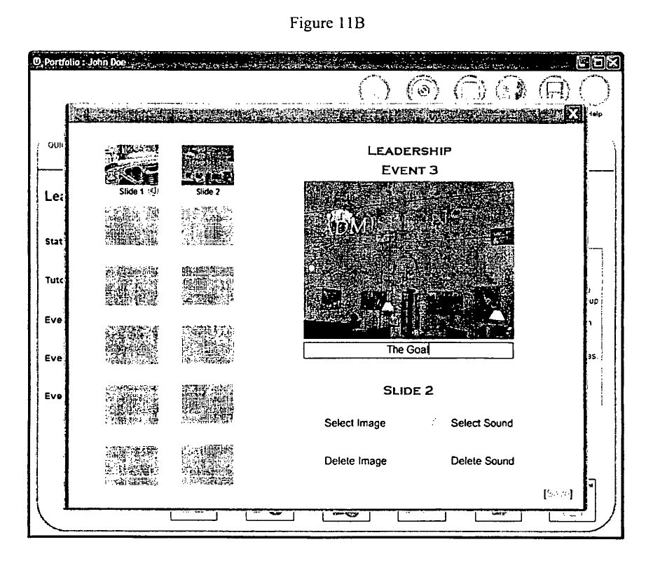

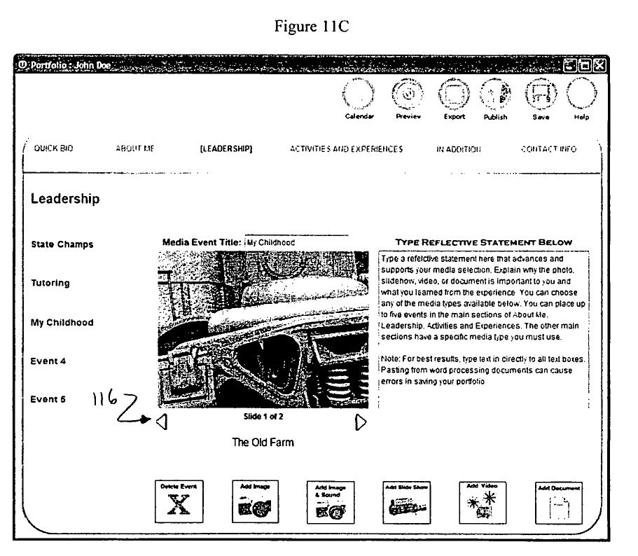

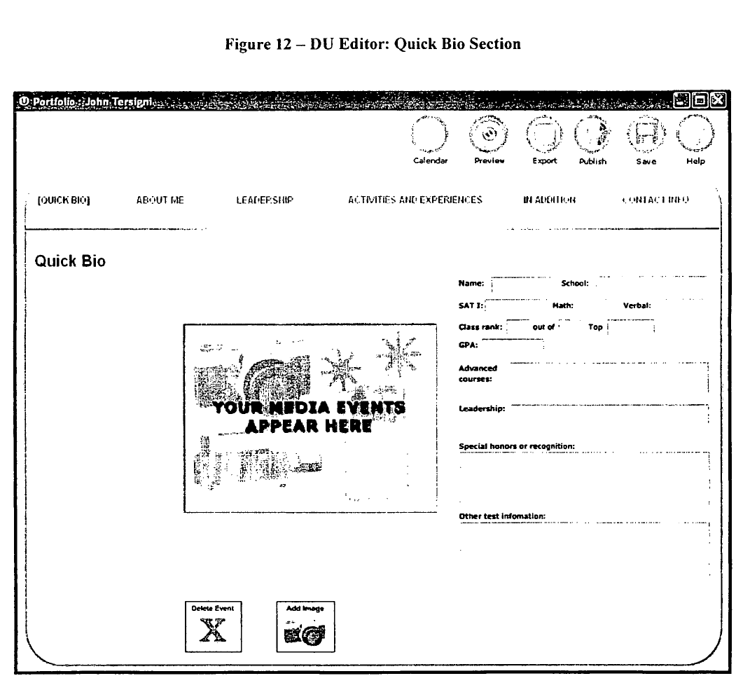

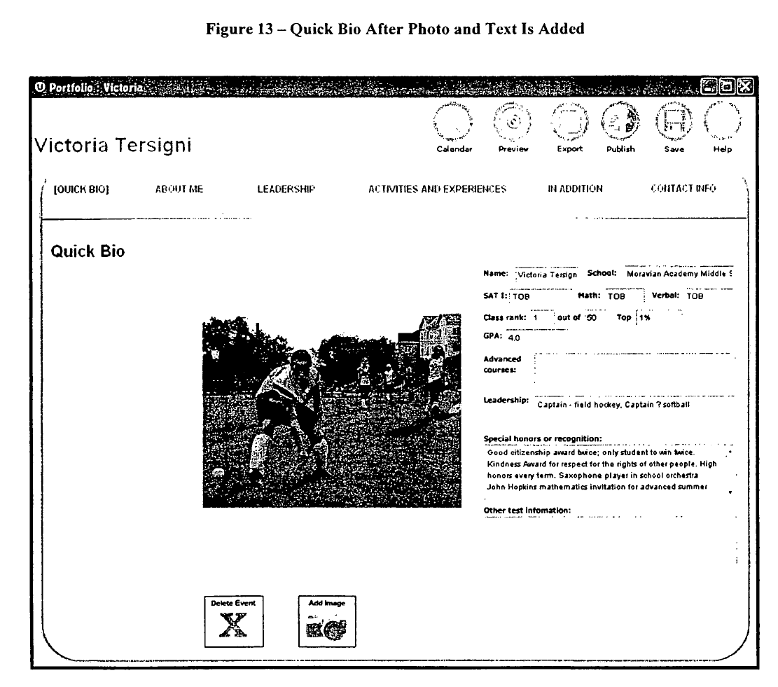

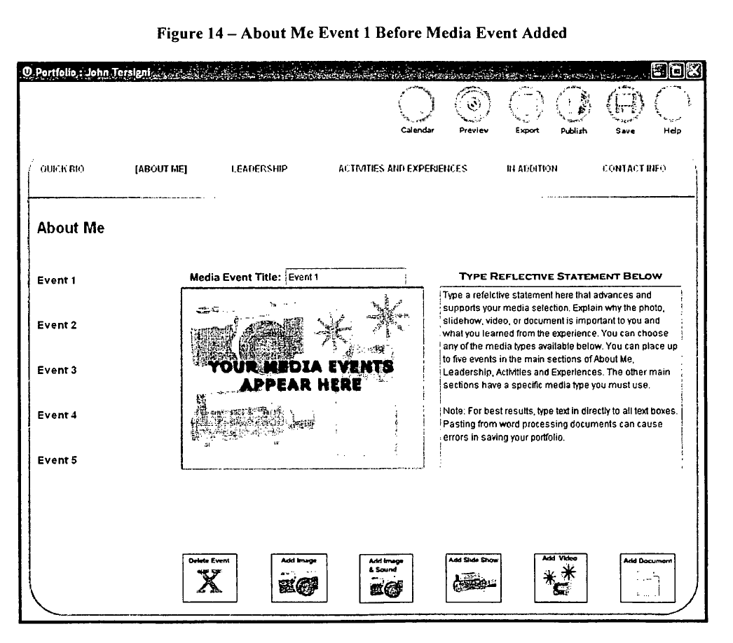

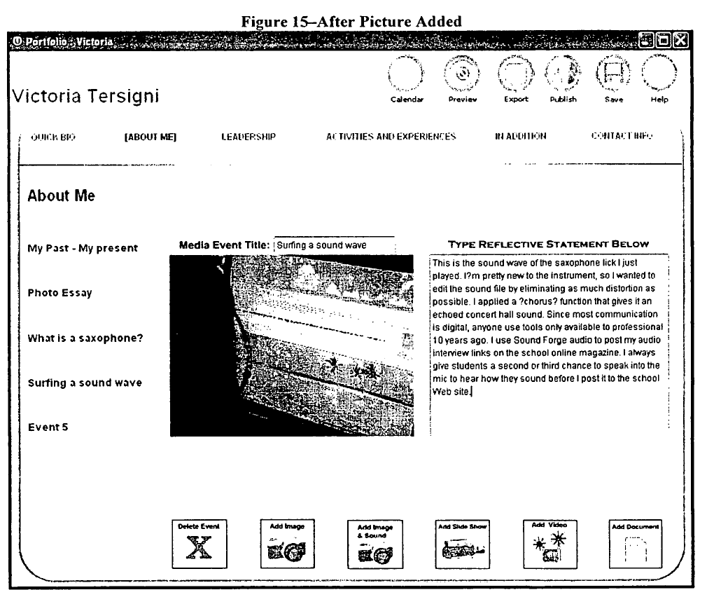

For example, selecting the “Add Slide Show” button launches a Slideshow building feature, such as the one shown in FIGS. 11A-11C. The present exemplary embodiment enables the insertion of up to 12 slides (image files) 110 in a single slide show. Selection of a thumbnail of the slide disposed in area 110 enables the editing of that particular selected slide.

The Slideshow building feature of FIGS. 11A-11C provides a topic section indicator 111, a media event indicator 112, a slide image media container box 113, a slide caption entry field 114, and a slide number indicator 115. The topic section indicator 111 displays the topic section in which the slide show will reside in the portfolio. The media event indicator 112 displays the particular media event to which the slide show belongs. In addition, the slide image media container box 113 provides instructions for the user and can also accept and display the image to be added. The slide caption entry field 114 receives text entry regarding a caption of the slide. Moreover, the slide indicator 115 can indicate the current slide number being modified or edited.

To add a slide, the user selects the “Select Image” button. When the “Select Image” button is selected, the user is prompted to navigate to a location where picture files are stored, and inserts a desired slide to the media container. The procedure is similar to the procedure for adding an images as disclosed above. When a sound selection option is chosen, such as when selecting the “Select Sound” button, the user is prompted to navigate to a location where sound files are stored. The user then selects the desired sound to accompany the selected slide, and inserts the selected sound. The selection of sound to accompany the selected slide is optional in this embodiment.

Once the selections are completed, accessing the save option saves both the image and sound selections. For example, the present invention matches the selected image with the selected sound upon selecting of the “Save” button, and both files are included as part of the portfolio. Selecting the save option also returns the application to the main Editor module, and the selected image and sound media event appears in the Editor window display. FIG. 16 shows an example in accordance with the embodiment, in which the selected image and selected sound have been saved and displayed on the Editor window.

A slide image or sound can be removed by selecting the delete features, such as by using the “Delete Image” and “Delete Sound” buttons. However, it is not necessary to remove an image or sound when replacing a previously saved file. A slide (with or without a sound) can be replaced by selecting the thumbnail of the slide to be replaced and by repeating the selection process, as disclosed above, for either the image or the sound. The delete buttons can be selected to permanently remove the slide (with or without the sound) without a replacement.

To add additional slides and sounds, the user selects one of the empty thumbnails located in area 110. The procedures discloses above are repeated with respect to selecting a slide and/or sound and replacing and deleting a slide and/or sound. Upon insertion of the additional slides, the slides will appear in area 110 in thumbnail form. If a slide is accompanied by a sound file, the present invention can display a sound indicator, such as a speaker icon, located under the thumbnail. This icon indicates that a sound associated with that slide. To add a caption for to a slide, the thumbnail of the slide is selected and the caption is entered in the caption entry field 114.

Once the selection of slides and/or sounds is completed, accessing the save option will save all the selections. For example, selecting the [Save] button saves the selected slides and/or sound and returns the application to the main Editor module. The selected slides and/or sounds then appear in the Editor window display, as shown in FIG. 11C.

To review the slide show, navigational icons/tools such as left and right arrow buttons 116, can be provided, as shown in FIG. 11C. Sounds will play automatically if present. To edit the slideshow, the Add Slideshow button is reselected from the media insertion bar.

Add Video

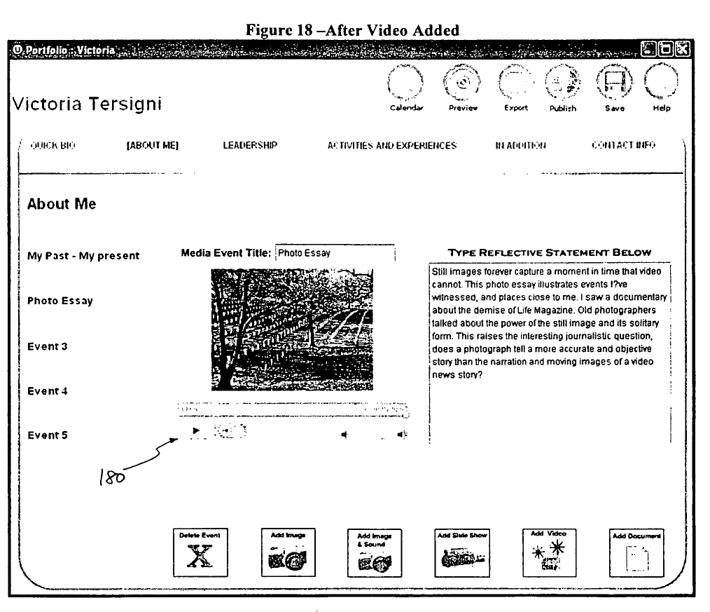

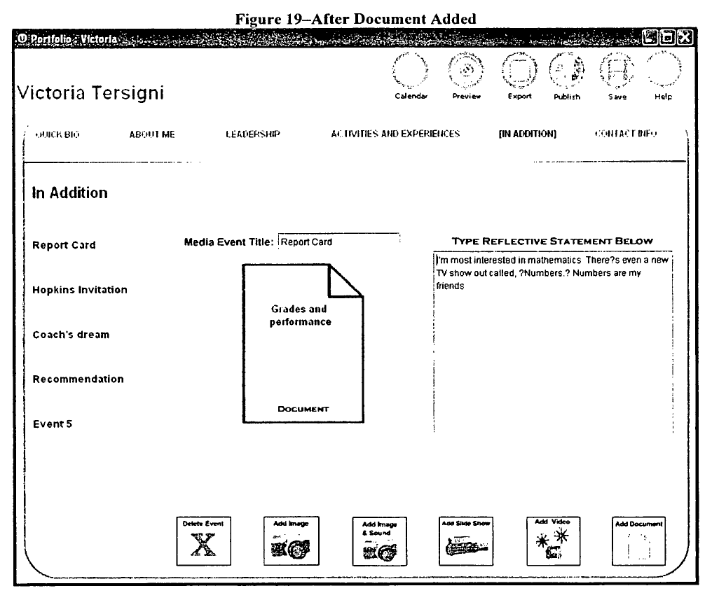

The media insertion/deletion bar shown in FIG. 7 also provides an “Add Video” selection button. When selected, the Editor module enables the insertion of a video file into the media container. In particular, selecting the “Add Video” button directs the user to a location storing video files, where the user navigates through the video files window to select the desired video. The selected video is then inserted into the media container. The selected video can be replaced when another video file is selected and inserted. Once the selected video appears in the Editor program, the video can be played using video playing tools and icons, such as the video control bar 180 shown in FIG. 18.

The present invention can accept videos in any format. FLV format, for example, produces good quality of a small file size. One embodiment of the present invention accepts FLV format videos and recommends Riva's FLV converter. Optional conversion is provided to allow video of non-standard format to be used.

Add Document

The media insertion/deletion bar shown in FIG. 7 also provides an “Add Document” selection button. When the “Add Document” button is selected, the user is prompted to navigate to a location where document files are stored. For example, selecting the Add Document button can open a document file selection window listing document files in any format, such as Microsoft Word® format (made by Microsoft Corp. of Redmond, Wash.), PDF format for use with Adobe® Acrobat files (made by Adobe Corp.), or the like. The user navigates within the file selection window and selects the document file/folder containing the desired document to be added to the portfolio. Upon selection, the document will appear in the Editor application module as part of the portfolio.

A title of the document can be entered directly on the document inserted in the media container. To view the document appearing in the media container, the user selects the document file, which causes the document to open, for examples in the text editor application.

Template Manager

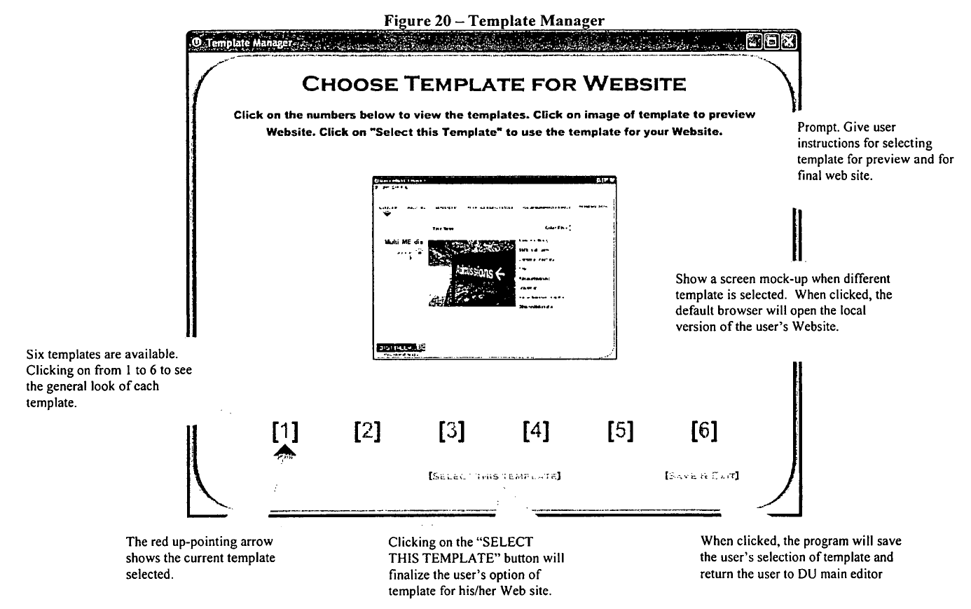

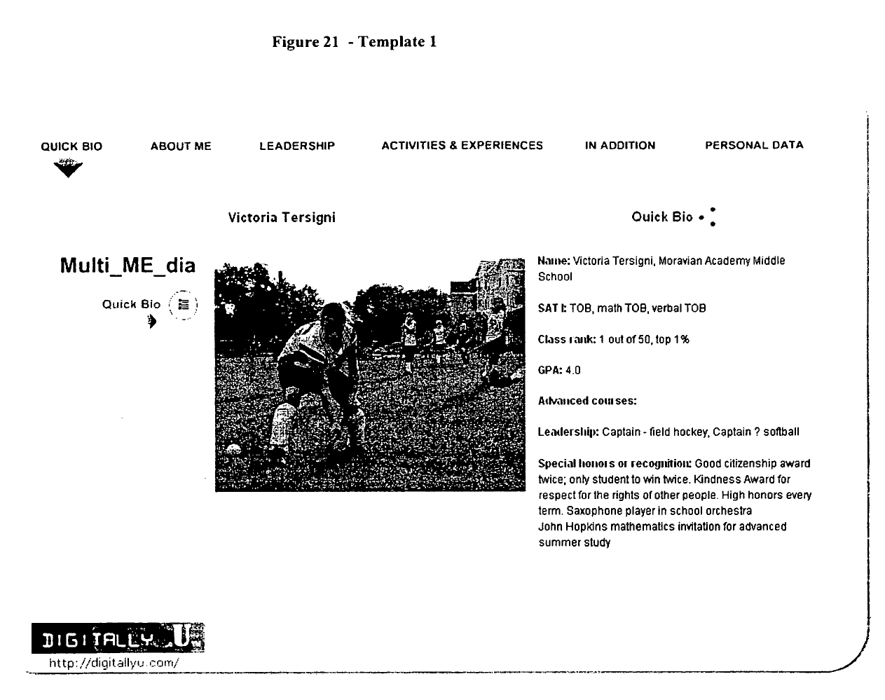

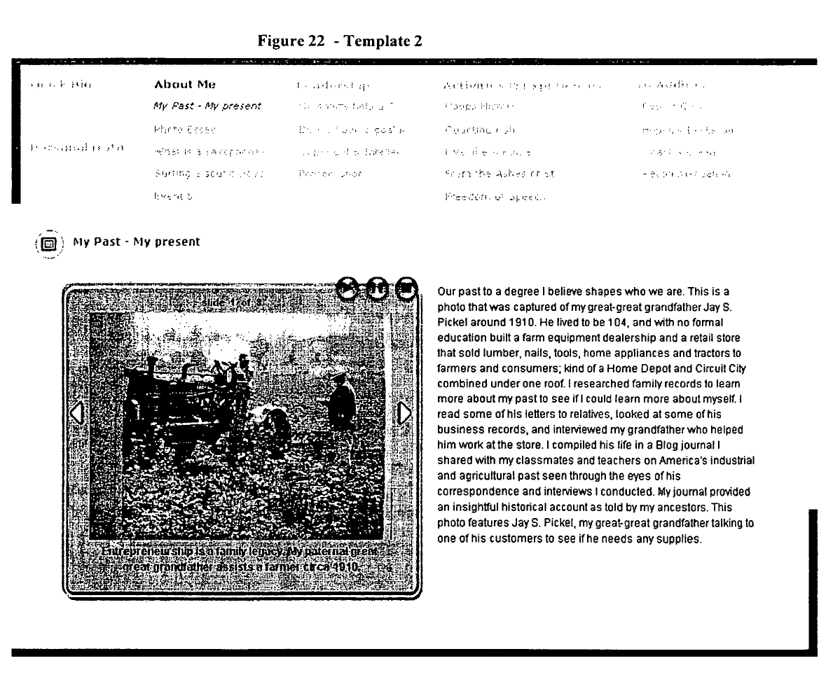

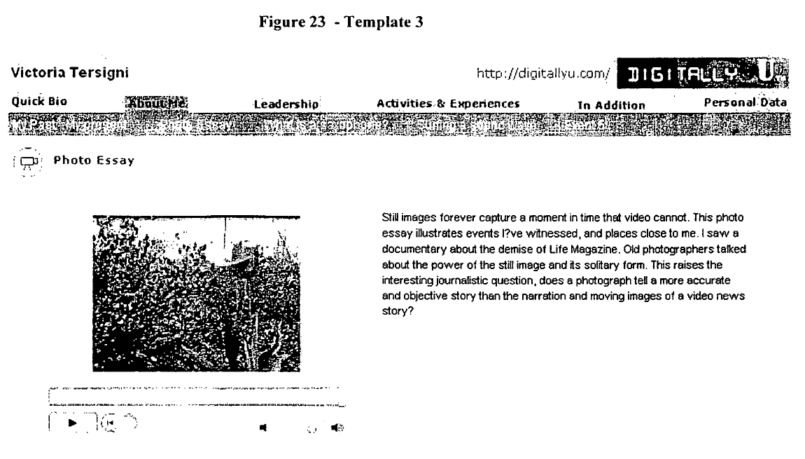

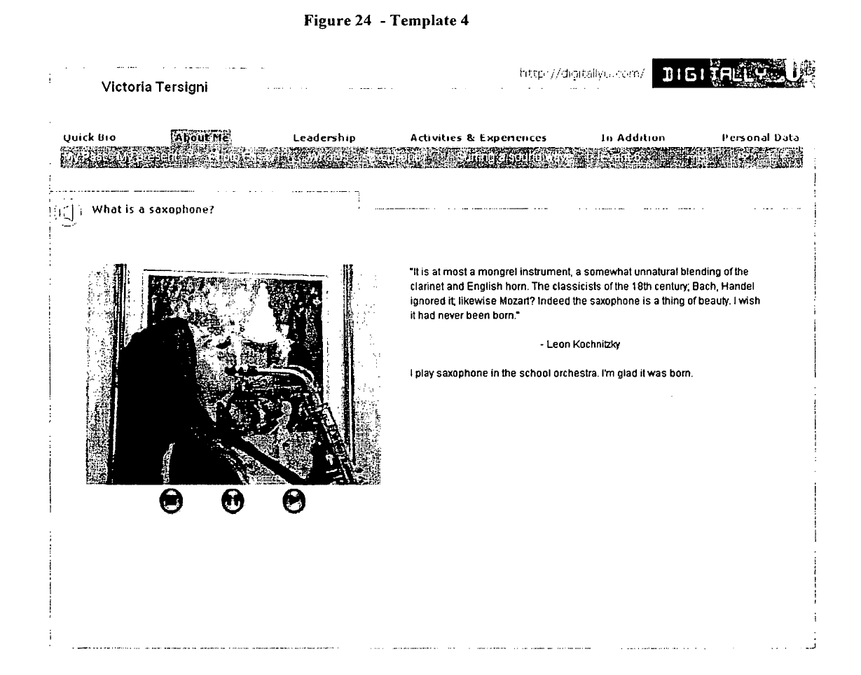

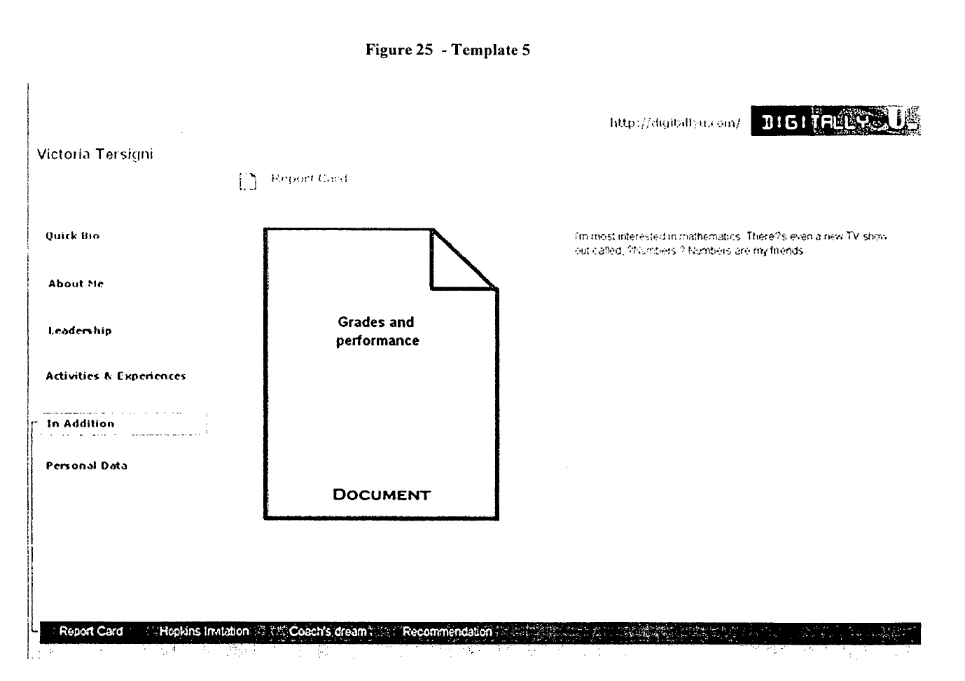

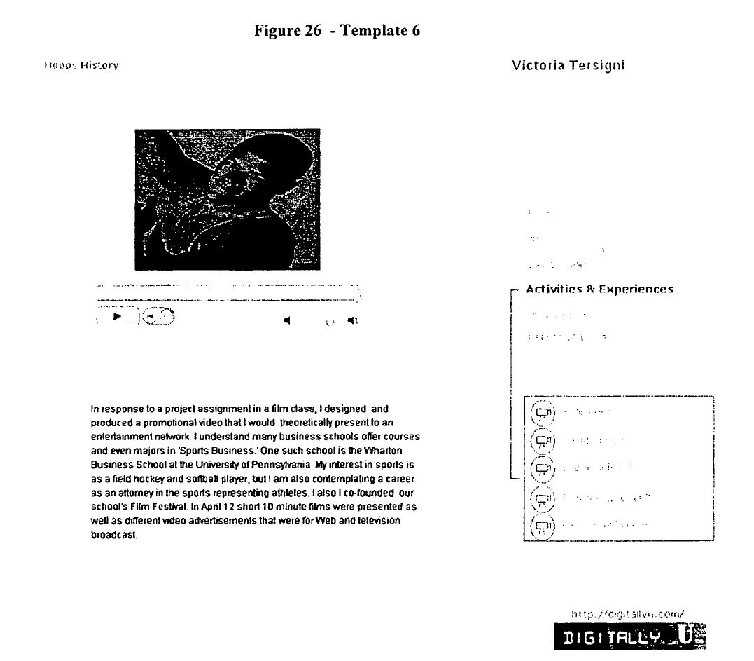

The Template Manager module of Digitally₁₃ U enables the selection of a particular layout from a predetermined group of templates for displaying and publishing the portfolio. The Template Manager also provides a preview function to allow viewing of the portfolio before publishing. FIG. 20 illustrates an example of the main Template Manager GUI screen, according to one embodiment of the present invention. In this example, six layouts are available for selection, although the present invention is not limited to six such selections.

Selecting a layout number on the bottom of the screen, as shown in FIG. 20, will enable the user to view the different layouts. To preview what the layout would look like as an online portfolio with the multimedia content included, the user selects the image of the layout in the center of the screen. This selection launches a browser and displays the contents of the portfolio, as it would appear on a network.

To select a layout template, the user selects the [Select this Template] button. The template selected is then indicated on the screen below the numbers menu. For example, an up-pointing arrow can indicate the currently selected layout template as shown in FIG. 20(?).

The user selects the [Save & Exit] button when the task is completed, and the Template Manager returns the user to the Editor program. The selected layout template can be changed at any time by repeating the above process.

Publisher

The Publisher module of Digitally₁₃ U provides a method for displaying and publish an exported portfolio on a network, such as the Internet. FIG. 9 shows one example of the Publisher GUI screen for one embodiment.

It is not necessary to use the Publisher if a FTP program is used in place thereof. If the Publisher is selected, the folder for publishing can be located in a folder, such as the “My Documents” folder. The folder will have the same name as provided for the portfolio during the creation process. The following processes illustrate one exemplary embodiment of the present invention, in which portfolios are published.

Publishing a Single Portfolio

1. Account information provided by the network hosting service is entered into the required fields in the Publisher program. The Publisher program will save the information entered, so that the next time the Publisher program is activated, the saved information is displayed.

2. The user clicks on the [Connect] button.

3. Two windows will open (see, e.g., FIG. 9A). One window contains the local folder, where the portfolio has been exported. The other window opens in a network browser and provides the location on the network hosting service at which the portfolio will be published.

4. To publish the portfolio, the user selects files in the local folder window. For example, executing the keystrokes of “ctrl+a” selects them all of the files.

5. The files are then dragged from the local folder window into the network browser window.

6. The present example commences the transfer process, and a progress box will appear.

7. When the transfer process is complete, both windows and the Publisher module are closed.

If the portfolio has already been published to a site on the network and new publishing is required such as after changes have been made, dragging the files that have changed into the network browers with updates the information to the published portfolio. Alternatively, files on the network site are deleted prior to dragging of the local files to the network browers so that only files that are currently being used are on the network site. This alternative approach can save storage space on the network site that would otherwise be taken up by files that may no longer be used.

Publishing Multiple Portfolios

The present invention enables a user to create a predetermined amount of portfolios, and can publish all of the predetermined portfolios created to the same network site or to different sites. Each time a new portfolio is published, it replaces the previous portfolio.

More than one portfolio can be placed on the same site, so long as each additional portfolio is supported by the particular structure of the web site. Each portfolio can have, for example, a different address, such as a different Uniform Resource Locator, and can be stored in a different folder on the network.

To publish multiple portfolios, the following actions are taken by the user for this exemplary embodiment:

1. The necessary information is entered into the Publisher module GUI screen of FIG. 9, and the two windows are launched as described above with regard to publishing a single portfolio.

2. In the Internet browser window, the user right clicks a blank area of the window to display the context menu.

3. New is then selected from the Context menu.

4. The user selects Folder from the New menu.

5. The folder is provided with a name that describes the portfolio. The folder name can be part of the URL that is used in network browsers to access this portfolio.

6. Steps 2 through 5 are repeated to create a folder for each portfolio intended to be published.

7. When the portfolio is ready for publishing, the user selects the folder in the browser window in which the portfolio will be stored.

8. The portfolio files are dragged from the local window into the folder in the browser window, as described under “to publish a single portfolio” above.

9. Steps 7 and 8 are repeated for each portfolio being published, with activity occurring inside the folder on the network site created for the portfolio. Each of the portfolios for publishing is opened, for example, using the Portfolio Manager application.

10. Upon finishing the publication of all of the portfolios, the windows and the Publisher application are closed.

This embodiment of the present invention also provides an alternate method for step nine above, such that it is not necessary to open each of the portfolios using the Portfolio Manager application. If the portfolios are exported to a folder, such as “My Documents” folder, publication of the portfolios can occur directly from those folders. The steps of this example are:

1. The user performs steps 1 through 8, as outlined above for the first portfolio.

2. In the local folder window the user navigates to the folder in the My Documents folders that has the same name as the second portfolio intended to be published. The user initiates all activity inside the portfolio folder in the local window. Also, all of the changes in all of the portfolios intended to be published are exported.

3. In the network browser, the user change to the folder created for the second portfolio.

4. The files for the second portfolio are dragged into the folder in the network browser window.

5. Steps 2 through 4 above are repeated for each portfolio intended to be published with activity occurring in the correct folders for both the local folder window and the network browser window.

When publishing multiple portfolios, each portfolio can have a different address locator, such as a different URL address. Each URL address can be, for example, the account name given by the hosting service, with the name of the folder created on the end. For example, if John Smith published 4 portfolios to his GeoCities account, the URLs would be as follows:
http://www.geocities.com/JohnSmith/Portfolio1
http://www.geocities.com/JohnSmith/Portfolio2
http ://www.geocities.com/JohnSmith/Portfolio3
http ://www.geocities.com/JohnSmith/Portfolio4

Once the portfolios have published, entering the address (e.g., the URL address) for the account provided by the web hosting service into a web browser launches that portfolio.

Structural Configuration

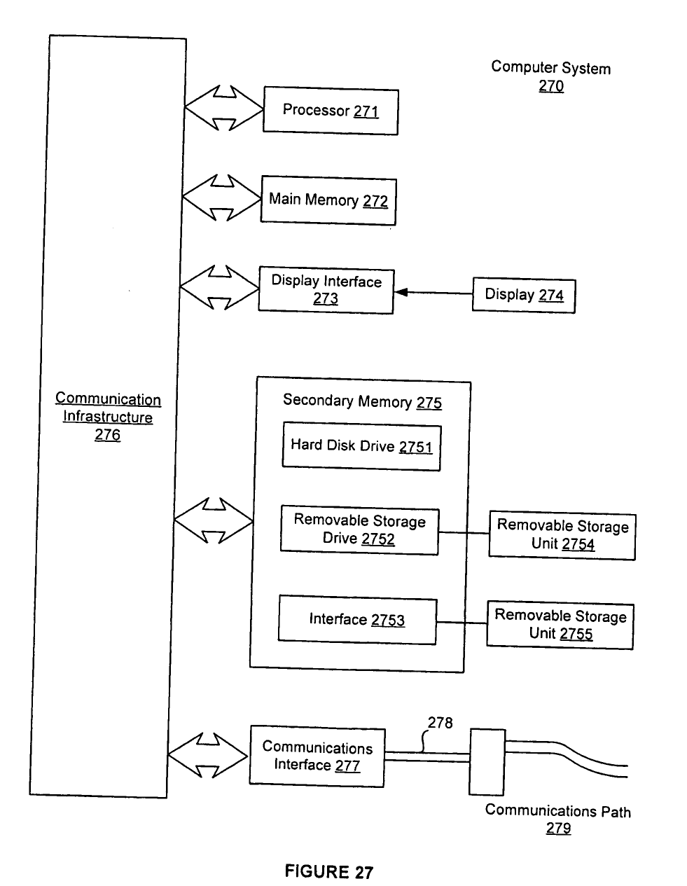

FIG. 27 illustrates a computer network system 270 that includes one or more processors, such as processor 271 for use in operation of various embodiments of the present invention. The processor 271 is connected to a communication infrastructure 276 (e.g., a communications bus, cross-over bar, or communication network). Various software embodiments are described in terms of this exemplary computer system. After reading this description, it will become apparent to a person skilled in the relevant art(s) how to implement the invention using other computer systems and/or architectures.

Computer system 270 can include a display interface 273 that forwards graphics, text, and other data from the communication infrastructure 276 (or from a frame buffer not shown) for display on the display unit 274. Computer system 270 also includes a main memory 272, preferably random access memory (RAM), and may also include a secondary memory 275. The secondary memory 275 may include, for example, a hard disk drive 2751 and/or a removable storage drive 2752, representing a floppy disk drive, a magnetic tape drive, an optical disk drive, or the like. The removable storage drive 2752 reads from and/or writes to a removable storage unit 2754. Removable storage unit 2754, represents a floppy disk, magnetic tape, optical disk, or the like, which is read by and written to removable storage drive 2754. As will be appreciated, the removable storage unit 2754 includes a computer usable storage medium having stored therein computer software and/or data.

In alternative embodiments, secondary memory 275 may include other similar devices for allowing computer programs or other instructions to be loaded into computer system 270. Such devices may include, for example, a removable storage unit 2755 and an interface 2753. Examples of such may include a program cartridge and cartridge interface (such as that found in video game devices), a removable memory chip (such as an erasable programmable read only memory (EPROM), or programmable read only memory (PROM)) and associated socket, and other removable storage units 2755 and interfaces 2753, which allow software and data to be transferred from the removable storage unit 2755 to computer system 270.

Computer system 270 may also include a communications interface 277. Communications interface 277 allows software and data to be transferred between computer system 270 and external devices such as servers, other computer systems, mobile device, etc. Examples of communications interface 277 may include a modem, a network interface (such as an Ethernet card), a communications port, a Personal Computer Memory Card International Association (PCMCIA) slot and card, etc. Software and data transferred via communications interface 277 are in the form of signals 278, which may be electronic, electromagnetic, optical or other signals capable of being received by communications interface 277. These signals 278 are provided to communications interface 277 via a communications path (e.g., channel) 279. This path 279 carries signals 278 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 2752, a hard disk installed in hard disk drive 2751, and signals 278. These computer program products provide software to the computer system 270. The invention is directed to such computer program products.

Computer programs (also referred to as computer control logic) are stored in main memory 272 and/or secondary memory 275. Computer programs may also be received via communications interface 277. Such computer programs, when executed, enable the computer system 270 to perform the features of the present invention, as discussed herein. In particular, the computer programs, when executed, enable the processor 271 to perform the features of the present invention. Accordingly, such computer programs represent controllers of the computer system 270.

In an embodiment where the invention is implemented using software, such as Digitally₁₃U, the software may be stored in a computer program product and loaded into computer system 270 using removable storage drive 2752, hard drive 2751, or communications interface 277. The control logic (software), when executed by the processor 271, causes the processor 271 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

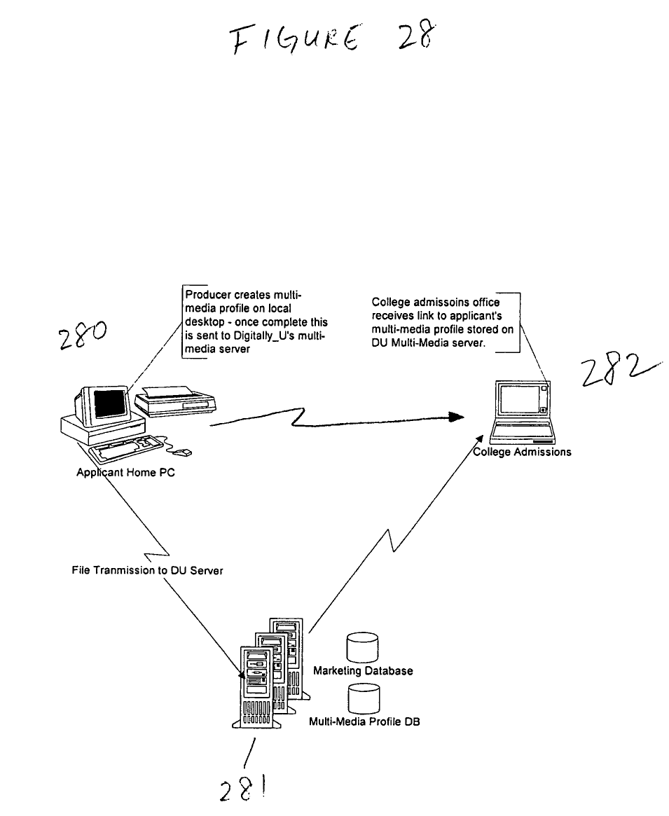

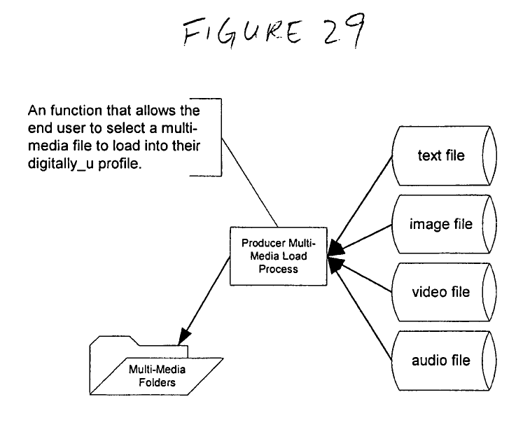

FIG. 28 shows an exemplary multimedia compiling and publishing system, in accordance with an embodiment of the present invention. As shown in FIG. 28, the system includes a terminal 280, such as a personal computer (PC), minicomputer, mainframe computer, microcomputer, telephonic device, or wireless device, such as a hand-held wireless device, accessible or operable by an accessor (also interchangeably referred to herein as a “user”). In one embodiment, the terminal 280 comprises at least two software components of Digitally₁₃U, the Multimedia Portfolio Producer and the centralized multi-media server and information repository. The Multimedia Portfolio Producer software can run locally on a user's terminal such as a personal PC. The Multimedia Portfolio Producer software enables end users to completely design and develop a multi-media profile, such as that disclosed above.

The terminal 280, in some embodiments, is optionally coupled to a server 281, such as a PC, minicomputer, mainframe computer, microcomputer, or other device having a processor and a repository for data and/or connection to a processor and/or repository for data, via, for example, a network, such as the Internet or an intranet, and couplings.

In one embodiment, the end user can publish a multi-media profile on a media server 281 coupled to a network, such as the Internet or the World Wide Web. After publishing the end user profile(s) on one or more media server(s), the end user can contact other parties potentially interested in accessing the profile, such as by sending invitations via email to a target audience, (e.g., college admission boards). The audience can accept the invitation and then be directed to the media server site, where they complete a brief registration process, for example, immediately followed by presentation of the owner's multi-media profile.

In an alternative embodiment, the Multimedia Portfolio Producer application tool can be made generally available to users on a network, such as the Internet or WWW. The Multimedia Portfolio Producer can be stored and set to operate on a host server and/or web page where users can access and use the Multimedia Portfolio Producer remotely via a network. The host server can require a fee, for example, to allow users to access and use the Multimedia Portfolio Producer. The host server can also be coupled to another server/location, such as university terminals connected to the network. In one embodiment, the host server can offer students access the Multimedia Portfolio Producer application stored on the host server. The students can compile, produce and publish their biographical resume/college applications on the host server's network site. The students can also designate college(s) they are interested in applying. The host server then allow(s) the students designated colleges to access such information, or the server can transmit the students files to the designated colleges for consideration.

In yet another embodiment of the present invention, the terminal 280 can be coupled to another server 282 associated with an educational institution. For example, a student can compile and produce a personal multimedia biographical portfolio, which can be in the form of an electronic college application, using the Multimedia Portfolio Producer running on terminal 280, the completed portfolio may then be transmitted to the server 282.

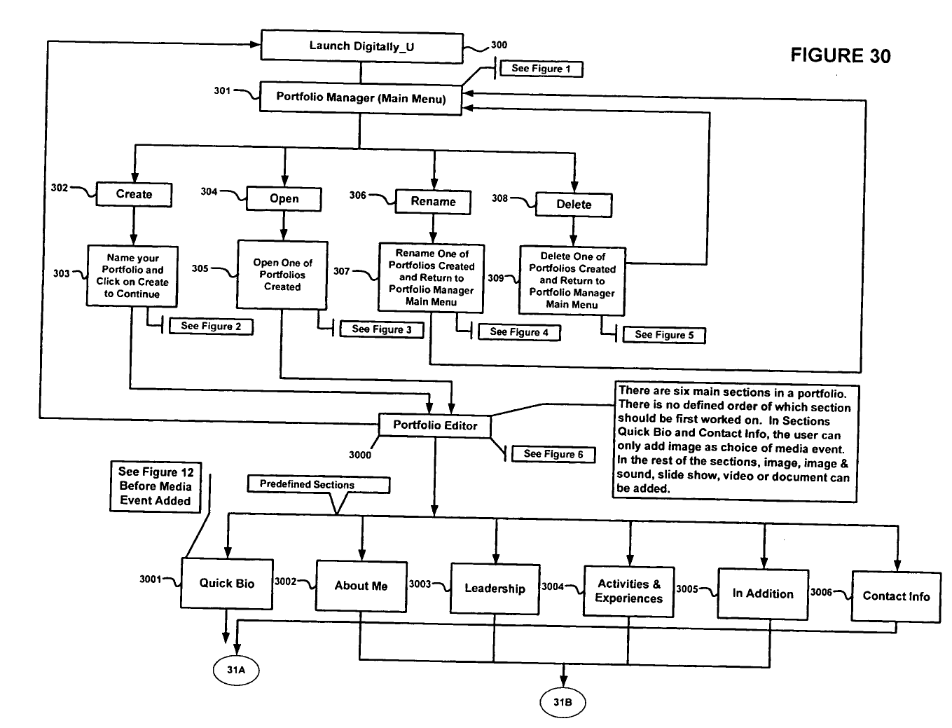

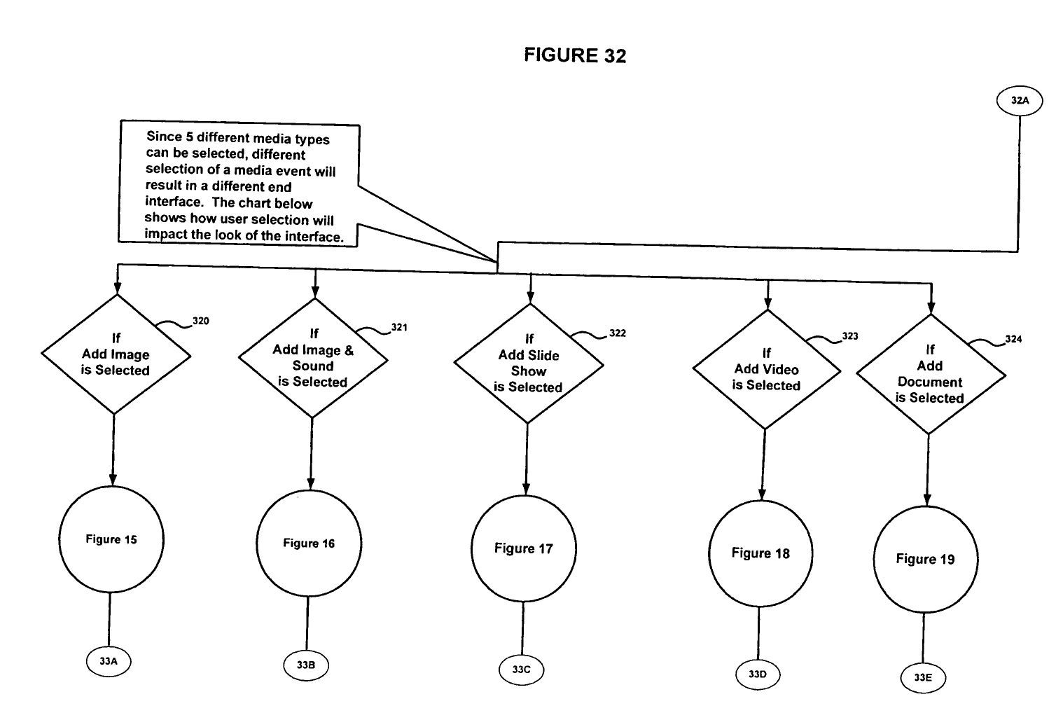

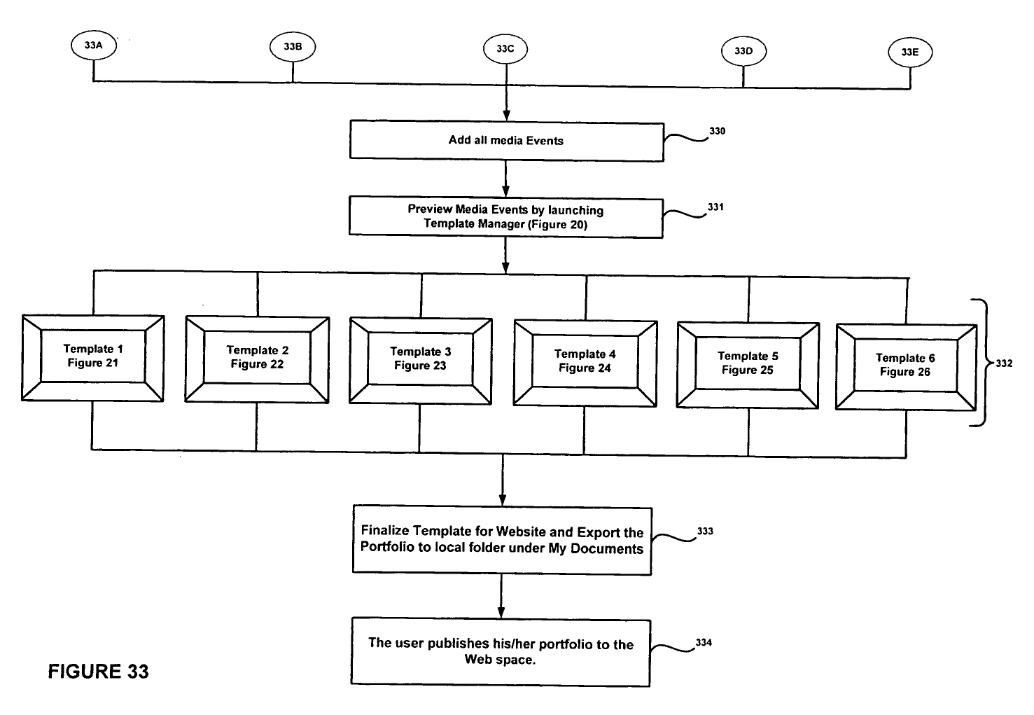

FIGS. 30-33 illustrate a flow diagram of a method for assimilating, compiling, inserting and network access enabling multimedia information, such as an individual user's biographical multimedia information or multimedia information for presentation purposes.

As shown in FIG. 30, in step 300, the user accesses and executes Digitally₁₃U. In other words, at step 300, the application of Digitally₁₃ U is launched for use. After launching and executing Digitally₁₃ U in step 301 the user is provided with access to a Portfolio Manager Entry Screen, which is the first and last screen appearing when a user opens or closes the Digitally₁₃ U system. At step 301, Digitally₁₃ U permits the selection of Create, Open, Rename and Delete functions. When Create is selected, in step 302, the user is provided with another screen (see e.g., FIG. 2) enabling the creation of a portfolio. At step 303, the user names the portfolio and selects the Create button to continue with the application process. The user then enters a name for the portfolio and selects the Create button to create the portfolio. This causes the DU Editor (FIG. 6) to open.

When Open is selected, in step 304, the user is provided with another screen (FIG. 3), and opens an existing portfolio is opened at step 305. The user selects on one of the existing folders to open for editing. When Rename is selected, step 306, the user is offered another screen (FIG. 4), allowing the user to rename an existing portfolio. The user selects a portfolio to rename by clicking on one of the folders shown, for example. Once the user selects a folder to rename, folder's name will appear the shown text box. Highlighting the previous name, the user types in the new name and clicks on Rename button to change the folder's name, and thus the portfolio's name. The updated name will then appear immediately in this screen. In step 307, the user is able to rename one of the existing portfolios and to return to the Portfolio Manager Main Menu.

When Delete is selected, in step 308, the system offers another screen (FIG. 5), allowing the user to delete an existing portfolio. In step 309, the user is able to delete one of the existing portfolios and to return to the Portfolio Manager Main Menu. As shown in FIG. 5, for example, the user selects a portfolio to delete by clicking on one of the folders shown. Once a folder is clicked on, its name will show in the text box. Clicking on the Delete button below the text box will then delete the selected portfolio.

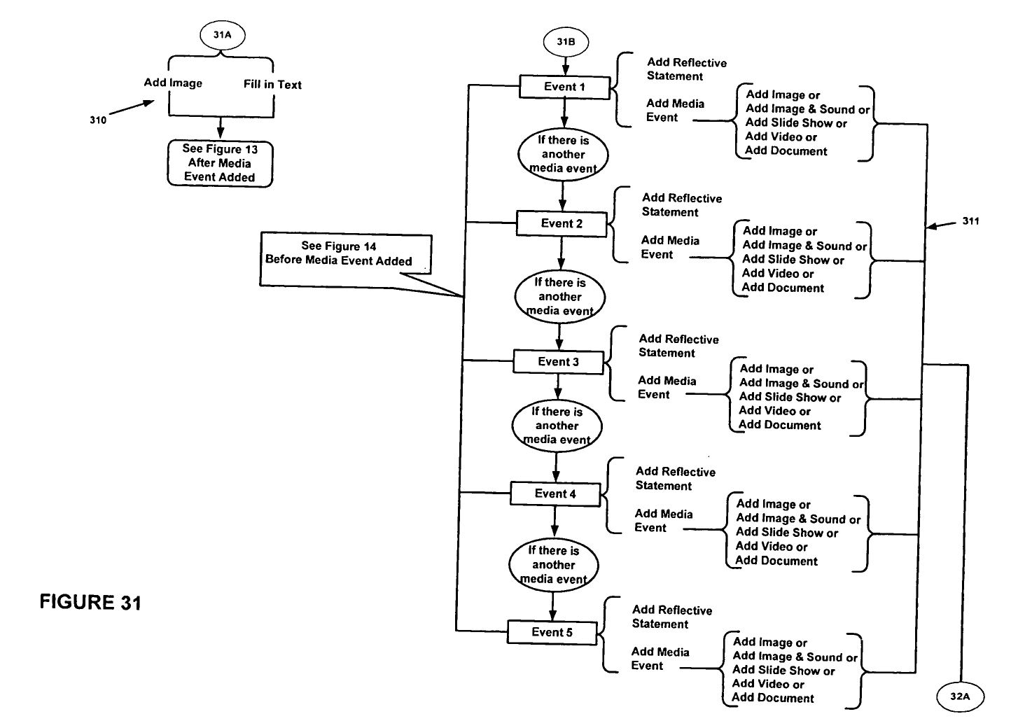

In step 3000, a default screen is provided when the user selects to create a new portfolio or to open an existing portfolio. At step 3000, the user is provided with one or more predetermined topic sections, such as Quick Bio, About Me, Leadership Activities and Experiences, In Addition, and Contact Info. Sections such as Quick Bio at step 3001 and Contact Info at step 3006 share similar interfaces because these two sections only allow users to add images and fill in text fields (e.g., at step 310 of FIG. 31). In the About me section, at step 3002, the Leadership section at step 3003, Activities and Experiences section at step 3004, and the In Addition section at step 3005 (see, e.g., FIG. 7), the user has more options as to how many and the types of media events that may be included.

As shown in FIG. 31, for each main section, except Quick Bio and Contact Info, the user is able, at step 311, to add a predetermined amount of media events (e.g., up to five media events. These media events include, for example, Image, Image plus Sound, Slide Show, Video, and Document.

When the Add Image option is selected, at step 320, the user is provided with a message to navigate to a location of the desired picture and to insert the picture into the Media Container. The picture will replace whatever was previously added. In addition, when the Add Image & Sound option is selected, in step 321, the DU Image plus Sound component editor executes and is displayed to the user. In step 321, the user inserts an image file and a sound file, such as mp3 file, into the Media Container.

When the Add Slide Show option is selected, in step 322, the system executes the DU Slide Show Editor (see, e.g., FIG. 11) and displays the GUI of the Editor on the display. In step 322, the user inserts a predetermined amount of slides (e.g., up to 12 slides) with sound files, such as mp3 files, into the Media Container.

When the Add Video option is selected, in step 323 the user is prompted to navigate to a location having the desired video such as video in FLV format, and to insert the file into the Media Container. In step 323, any video that was presentably added is replaced. When the Add Document option is selected, in step 324, the user is prompted to navigate to a location of the desired text document, such as a Word or PDF document, and to insert the document into the Media Container. A step 324, any document that was previously added is replaced.

At step 330, Digitally₁₃ U compiles all of the media events and the information entered by the user and executes the Template Manager of the present invention. At step 331, the present invention provides the user with a predetermined amount of selectable templates, such as six templates as provided in step 332, for the display formats of the compiled information and media events. For example, in step 331, the user is prompted with instructions for selecting a template for preview and display, such as on a web site. In step 331, a screen mock-up for a different template is presented. The default browser will open the local version of the user's network site, at Step 331, and the user can then select the selecting the “SELECT THIS TEMPLATE” button to finalize the user's selection of the template for the network site.

Upon selecting a template at step 332, Digitally₁₃ U executes, at step 333, finalization of the chosen template and export of the portfolio to a local folder, such as a folder located in the My Documents folder. For example, in step 333, the user is able to fill in the host name, making sure that the user's web hosting service allows ftp access. In addition, on step 333, the user can be requested to provide a name and a password associated with the web hosting service. When the Connect option is selected, on step 333, the access information is transmitted to Internet Explorer's₁₃ File Transfer Program. This step also causes two windows open. One window presents the user's local portfolio folder, under the My Documents folder for example, and the other closes the user's web space. The user can then drag and drop the local file to the network server, for example, and thus publish the site, as shown in step 334.

Having described and illustrated the principles of the invention with reference to a preferred embodiment, it will be apparent that the invention can be modified in arrangement and detail without departing from such principles. As such, it should be recognized that the detailed embodiment is illustrative only and should not be taken as limiting the scope of our invention.

1. A method for displaying a multimedia portfolio, the method comprising:
establishing a multimedia portfolio;
receiving multimedia content associated with a predetermined topic;
receiving a selection of a predetermined template for the display of the multimedia content;
and compiling the multimedia content based on the predetermined template.

2. The method of claim 1, wherein establishing the multimedia portfolio with the identifier comprises:
naming the multimedia portfolio.

3. The method of claim 1, wherein preparing the multimedia content associated with the predetermined topic comprises:
preparing the multimedia content associated with a predetermined event.

4. The method of claim 3, wherein preparing the multimedia content associated with the predetermined event comprises:
preparing a multimedia image content associated with predetermined event.

5. The method of claim 3, wherein preparing the multimedia content associated with the predetermined event further comprises:
preparing multimedia image content coupled with sound content associated with the predetermined event.

6. The method of claim 3, wherein preparing the multimedia content associated with the predetermined event further comprises:
preparing a multimedia slide show with a plurality of images, the multimedia slide show being associated with the predetermined event.

7. The method of claim 3, wherein preparing the multimedia content associated with the predetermined event further comprises:
preparing a multimedia slide show with a plurality of images, the multimedia slide show associated with the predetermined event.

8. The method of claim 3, wherein preparing the multimedia content associated with the predetermined event further comprises:
preparing a multimedia slide show with a plurality of images and with sound content, the multimedia slide show associated with the predetermined event:
wherein the sound content is associated with one of the plurality of image contents.

9. The method of claim 3, wherein preparing the multimedia content associated with the predetermined event further comprises:
preparing video content associated with the predetermined event.

10. The method of claim 1, wherein preparing the multimedia content associated with the predetermined event comprises:
preparing a text document associated with the predetermined event.

11. The method of claim 1, wherein displaying the multimedia portfolio comprises:
displaying the multimedia portfolio.

12. The method of claim 1, wherein displaying the multimedia portfolio comprises the step of publishing the multimedia portfolio on a network.

13. The method of claim 1, wherein the step of displaying the multimedia portfolio comprises the steps of:
transmitting the multimedia portfolio to a server coupled to a network;
publishing the multimedia portfolio on the network.

14. The method of claim 13, wherein the step of transmitting the multimedia portfolio comprises the step of transmitting the multimedia portfolio to a host server coupled to the Internet.

15. The method of claim 13, wherein the step of transmitting the multimedia portfolio comprises the step of transmitting the multimedia portfolio to a server coupled to an educational institution.

16. The method of claim 1, further comprising the step of displaying the multimedia portfolio.

17. A system for displaying a multimedia portfolio, the system comprising:
a processor;
a user interface functioning via the processor;
a repository accessible by the processor; and
a receiving device for receiving data for the processor,
wherein the processor, based on the data received from the receiving device, establishes a multimedia portfolio, receives multimedia content associated with a predetermined topic, and compiles the multimedia portfolio.

18. The system of claim 17, wherein the processor is housed in a terminal.

19. The system of claim 18, wherein the terminal is selected from a group comprising of a personal computer, a minicomputer, a main frame computer, a microcomputer, a hand held device, and a telephonic device.

20. The system of claim 17, wherein the server is coupled to a network.

21. The system of claim 20, wherein the network is selected from a group comprising of the Internet, the World Wide Web, a LAN, a WAN, and a wireless communication network.

22. The system of claim 20, wherein the server is coupled to the network via a coupling.

23. The system of claim 22, wherein the coupling is selected from a group comprising of a wired connection, a wireless connection, and a fiberoptic connection.

24. A computer-readable storage medium storing a computer-readable program for executing a method for displaying a multimedia portfolio, said method comprising the steps of:
establishing a multimedia portfolio;
preparing a multimedia content associated with a predetermined topic;
selecting a predetermined template for the display of the multimedia content;
compiling the multimedia content based on the predetermined template; and
displaying the multimedia portfolio.

25. A method for publishing an applicant's biographical multimedia portfolio, the method comprising:
creating a biographical portfolio;
establishing an identifier for the biographical portfolio;
inserting a multimedia content related to the applicant's biographical information into the portfolio;
receiving a selection of a predetermined template for displaying the multimedia content;
compiling the multimedia content based on the predetermined template; and
publishing the applicant's biographical multimedia portfolio.

26. The method of claim 25, wherein creating the biographical portfolio comprises creating the biographical portfolio for a student applying for college.

27. The method of claim 25, wherein the creating the biographical portfolio comprises creating the biographical portfolio for the applicant seeking a job.
